(19) United States
(12) Patent Application Publication
(10) Pub. No.: US 2025/0244943 A1
(43) Pub. Date: Jul. 31, 2025

(54) Systems and methods for remotely controlling electronic presentations

(71) Applicant: Canva Pty Ltd, Surry Hills (AU)

(72) Inventors: James Ross Burns, Sydney (AU); Fu Xiu Heng, Sydney (AU); Samuel Enoka, Sydney (AU); Ashwanth Fernando, Baulkham Hills (AU)

(73) Assignee: Canva Pty Ltd, Surry Hills (AU)

(21) Appl. No.: 19/183,771

(22) Filed: Apr. 18, 2025

Related U.S. Application Data
(63) Continuation of application No. 17/892,653, filed on Aug. 22, 2022.

(30) Foreign Application Priority Data
Aug. 23, 2021 (AU) 2021221388

(51) Int. Cl. G06F 3/14; G06F 3/0483; H04L 67/125

(52) U.S. Cl. CPC G06F 3/1454; G06F 3/0483; H04L 67/125

(57) ABSTRACT

Described herein is a computer implemented method. The method includes receiving a connect presenter request from a presenter application, the connect presenter request identifying a remote control session (RCS); establishing a RCS presenter connection with the presenter application; receiving a connect remote controller request from a remote controller application, the connect remote controller request identifying the RCS; and establishing a RCS remote controller connection with the remote controller application. The method further includes receiving, over the RCS remote controller connection, a remote controller-to-server command message defining a remote control command. In response, a server-to-presenter command message is generated which includes command data in respect of the remote control command. The server-to-presenter command message is then communicated to the presenter application over the RCS presenter connection.

### CROSS-REFERENCE TO RELATED APPLICATION

This application is a continuation application that claims priority to U.S. Non-Provisional application Ser. No. 17/892,653, filed Aug. 22, 2022, that claims priority to Australian Patent Application No. 2021221388, filed Aug. 23, 2021, which is hereby incorporated by reference in its entirety.

### TECHNICAL FIELD

The present disclosure is directed to systems and methods for remotely controlling electronic presentations.

### BACKGROUND

For many years, computer aided presentation tools have been used to assist in delivering presentations.

Initially, and generally speaking, such presentation tools involved software and hardware which could be used by a presenter to supplement their presentation with visual and/or audio content. In this case a presenter would present directly to an audience, referring to visual and/or audio aids provided by the presentation tool and appropriate audio visual hardware (e.g. a projector and speaker system or the like).

Such tools have evolved to platforms that allow presentations to be streamed to individual user computers—e.g. video and/or audio of a presenter speaking along with any supplemental audio and/or visual content (e.g. a presentation document or the like).

A significant challenge that exists with such platforms, however, is one of scalability: i.e. providing a presentation platform that can support multiple simultaneous presentations, each presentation potentially being delivered to a large number of participants.

Background information described in this specification is background information known to the inventors. Reference to this information as background information is not an acknowledgment or suggestion that this background information is prior art or is common general knowledge to a person of ordinary skill in the art.

### SUMMARY

Described herein is a computer implemented method including: receiving a connect presenter request from a presenter application, the connect presenter request identifying a remote control session (RCS), the RCS being associated with a presentation document; establishing a RCS presenter connection with the presenter application; receiving a connect remote controller request from a remote controller application, the connect remote controller request identifying the RCS; establishing a RCS remote controller connection with the remote controller application; receiving, over the RCS remote controller connection, a remote controller-to-server command message defining a remote control command; and in response to receiving the remote controller-to-server command message: generating a server-to-presenter command message, the server-to-presenter command message including command data in respect of the remote control command; and communicating the server-to-presenter command message to the presenter application over the RCS presenter connection.

Also described herein is a computer implemented method including: displaying, on a display, an initial page of a presentation document in a presentation user interface; joining a presentation session via which the initial page is displayed at a plurality of audience member client systems; establishing a remote control session (RCS) presenter connection with a server application, the RCS presenter connection being associated with a RCS, the RCS having a RCS identifier and being associated with the presentation document; receiving, over the RCS presenter connection, a page navigation message identifying a new page of the presentation document; and in response to receiving the page navigation message, updating the presentation user interface to display the new page; and causing the new page to be displayed at the plurality of audience member client systems.

Also described herein is a computer implemented method including: establishing a remote control session (RCS) remote controller connection with a server application, the RCS remote controller connection being associated with a RCS, the RCS having a RCS identifier and being associated with a presentation document; displaying, on a display, a remote control user interface, the remote control user interface including a page navigation control; detecting activation of the page navigation control; and in response to detecting activation of the page navigation control: determining a new page of the presentation document; generating a remote controller-to-server page navigation message identifying the new page; communicating the remote controller-to-server page navigation message to the server application over the RCS remote controller connection.

### BRIEF DESCRIPTION OF THE DRAWINGS

In the drawings:

FIG. 1 is a diagram depicting a networked environment in which various features of the present disclosure may be implemented.

FIG. 2 is a block diagram of a computer processing system configurable to perform various features of the present disclosure.

FIG. 3 depicts operations performed when a presenter client application enters a presentation mode.

FIG. 4 depicts operations involved to create a remote control session.

FIG. 5 depicts operations involved when a presenter client application attempts to connect to a remote control session.

FIG. 6 depicts operations involved when a presenter client application changes the state of a remote control session.

FIG. 7 depicts operations involved in processing a presenter-originating remote control event.

FIG. 8 depicts operations involved when a presenter client application receives a remote control session stream message.

FIG. 9 depicts operations involved when presenter client application disconnects from a remote control session.

FIG. 10 depicts operations involved when a remote controller client application attempts to connect to a remote control session.

FIG. 11 depicts operations involved in processing a remote controller-originating remote control event.

FIG. 12 depicts operations involved when a remote controller client application receives a remote control session stream message.

FIG. 13 depicts operations involved when remote controller client application disconnects from a remote control session.

FIG. 14 depicts operations performed by a server application on processing a remote control command from a stream of remote control commands.

FIG. 15 depicts operations performed by a server application on processing a state record from a stream of state records.

FIG. 16 depicts operations performed by a server application on detecting that a number of connected remote controllers has changed.

FIG. 17 depicts an example presentation user interface.

FIG. 18 depicts an example presentation user interface.

FIG. 19 depicts an example control for changing a remote control session state.

FIG. 20 depicts an example remote controller user interface.

FIG. 21 depicts an example control for selecting a presentation effect.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

The present disclosure is directed to electronic presentations. In particular, the present disclosure provides mechanisms by which participants in an electronic presentation can perform remote control actions. This is useful in a variety of situations, for example where a single electronic presentation has multiple presenters and/or one or more presenters do not have access to their computer while presenting (but do, for example, have access to a smart phone or similar device).

Consider, for example, an electronic presentation that is to be jointly delivered by a number of people. Conventionally, in such a situation, a primary presenter would initiate the electronic presentation and have control of the presentation—e.g. control over the slide show displayed and when pages of the slide show transition. During portions of the presentation when non-primary presenters are presenting, they need to ask the primary presenter to control page navigation—e.g. by a verbal or otherwise messaged ‘next page’ type requests to the primary presenter. Such requests typically interrupt the flow of a presentation for the actual person presenting, the primary presenter (who must watch for/respond to such requests), and the audience member (who are exposed to the “next page” request and/or delay in the presentation while the primary presenter takes the necessary action).

As a second example, consider a scenario where a presenter has prepared a presentation but at the time the presentation is to be delivered does not have access to their main computing device (e.g. a desktop/laptop or the like). In this case the presenter may ask someone else to start the presentation on their behalf and join the presentation using a mobile or the like. Once again, in such a situation a presenter would conventionally have to control the presentation by giving ‘next page’ or ‘please go to page x’ type requests to the user who has started/is controlling the presentation.

The techniques of the present disclosure address this by allowing certain participants in an electronic presentation to remotely control aspects of the presentation. Furthermore, the mechanisms described herein are scalable and can be used in presentation platforms that support many separate presentation sessions being held at the same time, each presentation session potentially having many audience members and multiple remote controllers.

The present disclosure is concerned with providing remote control mechanisms for electronic presentations. The electronic presentation itself may be established and managed in various ways. As one example, an electronic presentation session may be established and managed as described in International Patent Application No. PCT/AU2021/050501, entitled “Systems and methods for interactive presentations”, filed 26 May 2021, and claiming priority from Australian provisional patent application AU 2020901701 filed 26 May 2020. The contents of each of these applications are hereby incorporated by reference in their entirety. The techniques described herein may, however, be used (or be adapted to be used) with presentation sessions established in alternative ways.

The following paragraphs describe certain terms used throughout this specification.

As used herein, a remote control session (abbreviated to RCS) established in conjunction with a presentation session to facilitate the remote control functionality described herein. Broadly speaking, a RCS involves various computer applications (e.g. a presenter client application, one or more remote controller client applications, a server application) and RCS data that is generated, stored, and communicated between those applications.

As used herein, a presenter is a user who has (via a presenter client application) created a RCS.

As used herein, a remote controller is a user who has (via a remote controller client application) joined a RCS in order to remotely control certain aspects of the presentation session the RCS is associated with.

As used herein, a remote control command (abbreviated to RC command) is a command that is sent by a RCS controller (e.g. a presenter client application or remote controller client application) to affect the RCS in question. RC commands that originate from a presenter's client application will be referred to as presenter-originating RC commands. RC commands that originate from a remote controller's client application will be referred to as RC-originating RC commands. RC commands may be associated with a RC command type. In the present disclosure two specific RC command types are described (page navigation type RC commands and presentation effect type RC commands), however the techniques and features described herein can be adapted to be applied to additional and/or alternative types of RC commands.

RC commands are triggered by events that occur at a presenter or remote controller client application. As with RC commands, RC events may be presenter-originating (i.e. originating at a presenter client application and triggering emission of a presenter-originating command) or RC-originating (i.e. originating at a RC client application and triggering emission of a RC-originating command).

As used herein, a remote control command record is a data record that includes data describing a RC command.

As used herein, the remote control session state (RCS state) defines whether remote controllers are or are not able to issue RC commands to control the presentation in question. In the present embodiments RCS states include: enabled (in which case remote controllers can issue RC commands); disabled (in which case remote controllers cannot issue RC commands); and presenter disconnected (in which case remote controllers cannot issue RC commands)

As used herein, a remote control session identifier (RCS ID) uniquely identifies a RCS and can be used to connect to that RCS.

As used herein, a presentable is an electronic document that can be used in a presentation session—e.g. displayed to participants of the presentation. In the present embodiments, a presentable is made up of distinct pages that can be identified by a page identifier (e.g. a page index). During a presentation session the page of the presentable that is displayed to presentation participants is controlled by the presenter and/or any connected remote controllers. In PCT/AU2021/050501 a presentable is described as supplemental presentation data or content.

In alternative implementations, instead of being a single document a presentable may include multiple documents—e.g. a playlist or other set of documents. In this case, a page identifier (or page index) will identify both a specific document and a specific page of that document—e.g. an index may be a (document ID, page ID) tuple.

As used herein, a presentation effect is a predefined effect that can be triggered by a presenter (or remote controller) during a presentation and that is displayed (or played) for participants of the presentation. A presentation effect may have a visual and/or audio component. By way of example, presentation effects may include effects such as: a confetti effect that causes an animation of a confetti shower to be displayed on the current presentable page; a drumroll effect which causes an animation of a drum to be displayed and an audible drumroll to play; a quiet effect which causes an audible ‘shhh’ sound to be played; displaying a countdown timer (which may also include audible effects). Additional and/or alternative presentation effects may be provided.

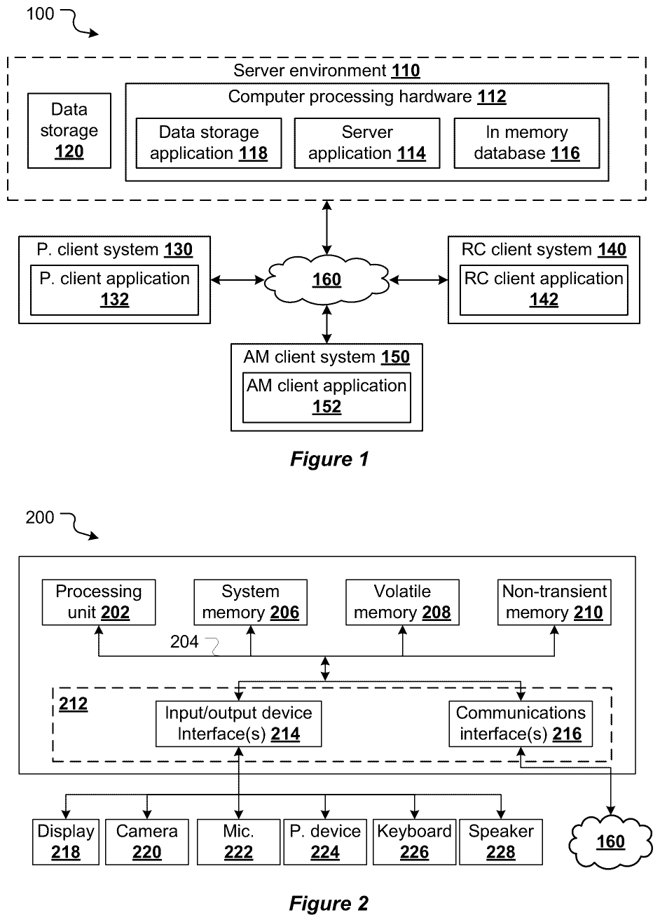

Turning to FIG. 1, a networked environment 100 will be described in which the various operations and techniques described herein can be performed.

Networked environment 100 includes a server environment 110, a presenter client system 130, a remote controller (RC) client system 140, and an audience member (AM) client system 150, all of which communicate via one or more communications networks 160 (e.g. the Internet).

Generally speaking, the server environment 110 includes computer processing hardware 112 (discussed below) on which applications that provide server-side functionality to client applications such as 132 and 142 (described below) execute. In the present example, server environment 110 includes a server application 114 (which may also be referred to as a front end server application), an in memory database (IMDB 116 for short) and a persistent data storage application 118.

The server application 114 executes to provide a client application endpoint that is accessible over communications network 160. To do so, the server application 114 may include one or more application programs, libraries, APIs or other software elements that implement the features and functions that are described herein. For example, where server application 114 serves web browser client applications the server application 114 will be a web server which receives and responds to, for example, HTTP application protocol requests. Where server application 114 serves native client applications, server application 114 will be an application server configured to receive, process, and respond to API calls from those client applications

The server environment 110 may include both web server and application server applications allowing it to interact with both web and native client applications.

In the present example the server environment 110 provides services/functions related to electronic presentations and as such will typically provide (alone or in conjunction with other server or client applications (such as 132 and 142)) functions such creating/saving/sharing presentables (e.g. electronic documents used in presentations), creating presentation sessions, inviting participants to presentation sessions and the like. In addition to the specific functionality described herein, the server application 114 (alone or in conjunction with other applications) may provide additional functions that are typically provided by server systems—for example user account creation and management, user authentication, and/or other server side functions.

In memory database (IMDB) 116 is used to create and manage remote control sessions. In the examples provided herein the IMDB 116 is a Redis data store, however alternative in-memory databases could be used, for example Dynamo or Memcached (though in this case the features described herein may need to be adapted for use with the alternative IMDB). Further, and as described in PCT/AU2021/050501, the IMDB 116 may be configured in a cluster mode for scalability—e.g. by dynamically provisioning shards for scalability (each shard potentially including master and replica for redundancy).

The persistent data storage application 118 executes to receive and process requests to persistently store and retrieve data that is relevant to the operations performed/services provided by the server environment 110. Such requests may be received from the server application 114, other server environment applications, and/or (in some instances) directly from client applications such as 132/142. Data relevant to the operations performed/services provided by the server environment 110 may include, for example, user account data, presentable data (i.e. data describing presentables that have been created or imported by users), and/or other data relevant to the operation of the server application 114 as described below.

The data storage application 118 may, for example, be a relational database management application or an alternative application for storing and retrieving data from data storage 120. Data storage 120 may be any appropriate data storage device (or set of devices), for example one or more non transient computer readable storage devices such as hard disks, solid state drives, tape drives, or alternative computer readable storage devices.

In server environment 110, server application 114 persistently stores data to data storage device 120 via the data storage application 118. In alternative implementations, however, the server application 114 may be configured to directly interact with data storage devices such as 120 to store and retrieve data (in which case a separate data storage application may not be needed). Furthermore, while a single data storage application 118 is described, server environment 110 may include multiple data storage applications. For example one data storage application 118 may be used for user data, another for document data, and one or more further data storage applications 118 used for data relating to the font replacement operations described herein. In this case, each data storage application may interface with one or more shared data storage devices and/or one or more dedicated data storage devices, and each data storage application may receive/respond to requests from various server-side and/or client-side applications (including, for example server application 114).

As noted, the server application 114, IMDB 116, and data storage application 118 run on (or are executed by) computer processing hardware 112. Computer processing hardware 112 includes one or more computer processing systems. The precise number and nature of those systems will depend on the architecture of the server environment 110.

For example, in one implementation, a single server application 114 and IMDB 116 run on one computer processing system and a single data storage application 118 runs on a separate computer processing system. In another implementation, a single server application 114, IMDB 116, and persistent data storage application 118 run on a common computer processing system. In yet another implementation, server environment 110 may include multiple server applications running in parallel (on one or multiple computer processing systems).

In a further implementation, server environment 110 is a scalable environment in which application instances (and the computer processing hardware 112—i.e. the specific computer processing systems required to run those instances) are commissioned and decommissioned according to demand—e.g. in a public or private cloud-type system. In this case, server environment 110 may simultaneously run multiple server applications 114, IMDBs 116, and/or multiple persistent data storage applications 118 (on one or multiple computer processing systems) as required by client demand. Where server environment 110 is a scalable system it will include additional applications to those illustrated and described. As one example, the server environment 110 may include a load balancing application which operates to determine demand, direct client traffic to the appropriate server application instance 114 (where multiple server applications 114 have been commissioned), trigger the commissioning of additional server environment applications (and/or computer processing systems to run those applications) if required to meet the current demand, and/or trigger the decommissioning of server environment applications (and computer processing systems) if they are not functioning correctly and/or are not required for current demand.

Communication between the applications and computer processing systems of the server environment 110 may be by any appropriate means, for example direct communication or networked communication over one or more local area networks, wide area networks, and/or public networks (with a secure logical overlay, such as a VPN, if required).

The present disclosure describes various operations that are performed by applications of the server environment 110. Generally speaking, however, operations described as being performed by a particular application (e.g. server application 114) could be performed by one or more alternative applications, and/or operations described as being performed by multiple separate applications could in some instances be performed by a single application.

Presenter client system 130 hosts a presenter client application 132 which, when executed by the presenter client system 130, configures it to provide client-side functionality/interact with server environment 110 (or, more specifically, the server application 114 and/or other application provided by the server environment 110). Via presenter client application 132, a user can interact with (for example) the server application 114 in order to perform various operations such as initiating a presentation and RCS.

Remote controller (RC) client system 140 hosts a remote controller (RC) RCA 142 which, when executed by the RC client system 140, configures it to provide client-side functionality/interact with server environment 110 (or, more specifically, the server application 114 and/or other application provided by the server environment 110). Via RC RCA 142, a user can join a RCS that has been created by a presenter client system 132 and generate/issue remote control commands.

Audience member (AM) client system 150 hosts an audience member (AM) client application 152 which, when executed by the AM client system 150, configures it to provide client-side functionality/interact with server environment 110 (or, more specifically, the server application 114 and/or other application provided by the server environment 110). Via AM client application 152, a user can join a presentation session to watch a presentation.

Presenter, RC, and AM client applications 132/142/152 may be the same application (albeit running on different devices and in different modes of operation). Alternatively, presenter/RC/AM client applications 132/142/152 may be different applications. For example: presenter client application 132 may be an application that provides a wide variety of functions (e.g. creating presentables, initiating presentations, initiating remote control sessions, displaying a presentable (and other presentation) data throughout a presentation); RC RCA 142 may provide more limited functionality (e.g. joining a RCS and issuing specific remote control commands as facilitated by the RCS); AM client application 152 may provide functionality for joining a presentation session and watching a presentation.

Each of the presenter, RC, and/or AM client applications 132/142/152 may be a general web browser application which accesses the server application 114 via an appropriate uniform resource locator (URL) and communicates with the server application 114 via general world-wide-web protocols (e.g. http, https, ftp). Alternatively, each of the presenter, RC, and/or AM client applications 132/142/152 may be a native application programmed to communicate with server application 114 using defined application programming interface (API) calls.

While only one presenter/RC/AM client system 130/140/150 (and one presenter/RC/AM client application 132/142/152) are depicted in network 100, server environment 110 will typically serve many more clients—e.g. multiple presenter client applications 132, multiple RC client applications, and multiple AM client applications 152.

For brevity, the following acronyms will be used at times throughout this description: PCS 130 for presenter client system; PCA 132 for presenter client application; RCS 140 for remote controller client system; RCA 142 for remote controller client application; AMS 150 for audience member client system; ACA 152 for audience member client application.

Reference in this disclosure to functionality provided by a presentation platform is reference to functionality that is provided by the various applications depicted in network environment 100 (e.g. the applications of server environment 110, the PCA 132, the RCA 142, and the ACA 152). In some instances a given presentation platform function will require some (or even all) of the various applications depicted in network environment 100, while others may rely on a single application of environment 100 only.

The techniques and operations described herein are performed by one or more computer processing systems.

The computer processing hardware 112 (on which the applications of server environment 110 are executed) will also include one or more computer processing systems. Server environment computer processing systems will typically be server systems, though may be any appropriate computer processing systems.

Each presenter, remote controller, and audience member client system 130/140/150 will also be a computer processing system—for example a desktop computer, laptop computer, tablet computing device, mobile/smart phone, or other appropriate computer processing system.

FIG. 2 provides a block diagram of a computer processing system 200 configurable to implement embodiments and/or features described herein. System 200 is a general purpose computer processing system. It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable by (either in a shared or dedicated manner) system 200.

Through a communications bus 204 the processing unit 202 is in data communication with a one or more machine readable storage (memory) devices which store computer readable instructions and/or data which are executed by the processing unit 202 to control operation of the processing system 200. In this example system 200 includes a system memory 206 (e.g. a BIOS), volatile memory 208 (e.g. random access memory such as one or more DRAM modules), and non-transient memory 210 (e.g. one or more hard disk or solid state drives).

System 200 also includes one or more interfaces, indicated generally by 212, via which system 200 interfaces with various devices and/or networks. Generally speaking, other devices may be integral with system 200, or may be separate. Where a device is separate from system 200, connection between the device and system 200 may be via wired or wireless hardware and communication protocols, and may be a direct or an indirect (e.g. networked) connection.

Wired connection with other devices/networks may be by any appropriate standard or proprietary hardware and connectivity protocols. For example, system 200 may be configured for wired connection with other devices/communications networks by one or more of: USB; eSATA; Ethernet; HDMI; and/or other wired connections.

Wireless connection with other devices/networks may similarly be by any appropriate standard or proprietary hardware and communications protocols. For example, system 200 may be configured for wireless connection with other devices/communications networks using one or more of: BlueTooth; WiFi; near field communications (NFC); Global System for Mobile Communications (GSM), and/or other wireless connections.

Generally speaking, and depending on the particular system in question, devices to which system 200 connects—whether by wired or wireless means—include one or more input devices to allow data to be input into/received by system 200 and one or more output devices to allow data to be output by system 200. In the present example, input/output devices interface with system 200 via one or more input/output device interfaces 214. Example devices are described below, however it will be appreciated that not all computer processing systems will include all mentioned devices, and that additional and alternative devices to those mentioned may well be used.

For example, system 200 may include or connect to one or more input devices by which information/data is input into (received by) system 200. Such input devices may include keyboard, mouse, trackpad, microphone, accelerometer, proximity sensor, GPS, and/or other input devices. System 200 may also include or connect to one or more output devices controlled by system 200 to output information. Such output devices may include devices such as a display (e.g. a LCD, LED, touch screen, or other display device), speaker, vibration module, LEDs/other lights, and/or other output devices. System 200 may also include or connect to devices which may act as both input and output devices, for example memory devices (hard drives, solid state drives, disk drives, and/or other memory devices) which system 200 can read data from and/or write data to, and touch screen displays which can both display (output) data and receive touch signals (input).

By way of example, where system 200 is a client system such as 130/140/150 it may include a display 218 (which may be a touch screen display), a camera device 220, a microphone device 222 (which may be integrated with the camera device), a pointing device 224 (e.g. a mouse, trackpad, or other pointing device), a keyboard 226, and a speaker device 228.

System 200 also includes one or more communications interfaces 216 for communication with a network, such as network 160 of environment 100 (and/or a local network within the server environment 110). Via the communications interface(s) 216, system 200 can communicate data to and receive data from networked systems and/or devices.

System 200 may be any suitable computer processing system, for example, a server computer system, a desktop computer, a laptop computer, a netbook computer, a tablet computing device, a mobile/smart phone, a personal digital assistant, or an alternative computer processing system.

System 200 stores or has access to computer applications (also referred to as software or programs)—i.e. computer readable instructions and data which, when executed by the processing unit 202, configure system 200 to receive, process, and output data. Instructions and data can be stored on non-transient machine readable medium such as 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, and referring to the networked environment of FIG. 1 above, server environment 110 includes one or more systems which run a server application 114, IMDB 116, and a persistent data storage application 118. Similarly, client systems 130/140/150 run client applications 132/142/152 respectively.

In some cases part or all of a given computer-implemented method will be performed by system 200 itself, while in other cases processing may be performed by other devices in data communication with system 200.

### Remote Control Session Data

In order to facilitate presentation remote control, server application 114 generates and maintains remote control session data (RCS data). Generally speaking, the RCS data for a given RCS session includes RCS metadata, RCS state data, and RCS remote control commands data (RC commands data for short). A specific example of RCS data in accordance with one particular implementation is described below, however, additional and/or alternative data (maintained in different data types and/or by different data storage mechanisms) is possible.

For a given RCS, the RCS metadata created and stored by server application 114 for each active RCS includes: a RCS identifier string; a RCS metadata hash; a RCS controller count string; and a RCS presenter count string.

In the present embodiments, the RCS state data created and stored by server application 114 for each active RCS includes data that defines the state of the RCS. In the described embodiments RCS states define the state of the entire RCS and include enabled (in which state RC commands can be issued and processed), disabled (in which case RC commands cannot be issued and/or are not processed), and presenter-disconnected states (indicating the presenter has disconnected from the RCS and in which case RC commands cannot be issued and/or are not processed).

In certain embodiments, mechanisms for more granular control of remote control permissions may also (or alternatively) be provided. More granular permissions may, for example, be defined with reference to specific users (and/or user groups and/or user roles), specific RC command types, and/or based on other criteria. For example, the RCS state data may define that (at a given time during a RCS) a particular remote controller can make use of one or more specific RC command types, all RC command types, or no RC command types. As one example, this permissions mechanism could be used by a presenter (or other relevantly permissioned user or application) to selectively enable remote control functions for a particular remote controller (or remote controller group) when it is their turn to present then disable remote control functions for that remote controller (or remote controller group) when it is not their turn to present.

More granular remote control permissions may be provided via the RCS state mechanism as described herein (e.g. with appropriate changes to state messages and state message processing), or by a separate permissions mechanism that runs in conjunction with the RCS state mechanism. In this case, the RCS state mechanism is used to control broad states (e.g. enabled/disabled/presenter disconnected states) and the further permissions mechanism is used to control specific states for (for example) particular users, user groups, user roles, RC command types.

In the present embodiments, the RC commands data created and stored by server application 114 for each active RCS includes data that defines remote control commands that have been issued in respect of the RCS.

1004267837

In the present embodiments, the server application 114 is configured to store data in respect of each different RC command type in a separate data structure. The specific examples provided below include a RCS page navigation commands stream (for storing RC page navigation type commands) and a RCS presentation effect commands stream (for storing RC presentation effect type commands). While streams have been used as specific example data structures, alternative data structures which provide for an ordered set of items could be used.

Providing a separate data structure for each different RC command type facilitates fine-grained control of what types of RC commands are enabled/disabled in a given RCS, what events are to be read and processed, and avoiding reading full event histories for event types that are not of concern when (re) connecting presenters and remote controllers to a RCS. In alternative implementations, however, server application 114 may be configured to store data for all RC commands in a single data structure, or to group data for one or more selected RC command types into a single data structure.

In the described implementation, server application 114 maintains RCS data in an in memory database 116. The specific IMDB 116 that is used in the described embodiments is a Redis database. In this context, and for illustrative purposes, specific example key/value pairs for the above RCS data items are provided below, though it is again noted that alternatives are possible:

In the present example, a RCS identifier string is created and stored in the IMDB 116 for each RCS. In this example, the key of the RCS identifier string takes the following format:
remote: user:<presenter user ID>: presentable:<presentable ID>

The value of a RCS identifier string is the identifier of the RCS that matches the user ID, type, and presentable ID defined in the Key.

Where presentations are created/made available as described in PCT/AU2021/050501, the RCS ID is separate to the presentation session identifier. In PCT/AU2021/050501, the presentation session identifier is known to all participants of the presentation as it is used to allow the participants to connect to the presentation session. It will not, however, typically be desirable to provide all participants the RCS ID which (if done) would allow all participants to connect as remote controllers.

In the present example, a RCS metadata hash is created and stored in the IMDB 116 for each RCS. In this example, the key of the RCS metadata hash takes the following format:
remote:{<RCS ID>}:metadata

The value of a RCS metadata hash includes the following fields of metadata that are related to the RCS defined in the key: the RCS ID of the RCS; the user ID of the presenter associated with the RCS; the presentable ID of the presentable associated with the RCS; a session start timestamp recording a start time of the RCS. In the example data specification below, the “message RemoteMetadataRecord” and associated data structures provide an example data structure for the RCS metadata hash.

In the present example, a RCS controller count string is created and stored in the IMDB 116 for each RCS. In this example, the key of the RCS controller count string takes the following format:
remote:{<RCS ID>}:controllercount

The value of a RCS controller count string indicates the number of remote controllers that are currently connected to the RCS identified in the key. In the present embodiments, the controller count string is a non-negative integer.

In the present example, a RCS presenter count string is created and stored in the IMDB 116 for each RCS. In this example, the key of the RCS presenter count string takes the following format:
remote:{<RCS ID>}:presentercount

The value of a RCS presenter count string indicates the number of currently connected presenters to the RCS identified in the key. In the present embodiments this value is either 0 or 1.

In the present example, a RCS state stream is created and stored in the IMDB 116 for each RCS. In this example, the key of the RCS state stream takes the following format:
remote:{<RCS ID>}:stream:state

Each item in the RCS state stream is a RCS state record. Each RCS state record defines a record creation timestamp and a RCS state—in this case: an enabled state (indicating that remote control functionality for the RCS as a whole is enabled); a disabled state (indicating that remote control functionality for the RCS as a whole is disabled); or a presenter disconnected state (indicating that the presenter is not connected to the RCS—in which case remote control functionality for the RCS as a whole is also disabled). In the present example, a RCS state record that defines an enabled state additionally defines a page identifier (being a page of the presentable associated with the RCS that was current at the time the state record was created) and a maximum pages value (indicating a number of pages in the presentable at the time the state record was created).

In the example data specification provided, below, the “message RemoteControlEventRecord” and associated data structures provide an example data structure for each RCS state record that is added to the RCS state stream.

The most recent RCS state record in the RCS state stream defines the current state of the RCS—i.e. enabled, disabled, or presenter disconnected.

In the present example, a RCS remote control commands stream is created and stored in the IMDB 116 for RCS and each type of RC command that is facilitated.

In the present example, a RCS page navigation commands stream and a RCS effects commands are created and stored in the IMDB 116 for each RCS.

In this example, the key of the RCS page navigation commands stream takes the following format:
remote:{<RCS ID>}:stream:navigation

Each item in the RCS page navigation commands stream is a page navigation command record which defines a destination page—i.e. a page of the presentable associated with the RCS that the page navigation command causes navigation to. In the example data specification below, the “message PageNavigationCommandRecord” provides an example data structure for each page navigation command record.

In this example, the key of the RCS effects commands stream takes the following format:
remote:{<RCS ID>}:stream:effects

Each item in the RCS effects commands stream is a presentation effect command record which defines a specific presentation effect. In the present embodiments, presentation effects are defined by an effect enum value, e.g. (confetti, drumroll, quiet, timer, and so forth. In the example data specification below, the “message PresentationEffectCommandRecord” provides an example data structure for each presentation effect command record.

Additional streams (or other data structures) may be created to store data in respect of other RC command types that are made available by the presentation platform.

In the above examples, certain key elements are provided in braces—e.g. {<key element>}. These elements are referred to as hash tags and are used to determine which hash slot, and therefore which particular shard, the data is stored on. In order to allow atomic operations across multiple keys, those keys must exist in the same hash slot. In the present disclosure, being able to operate atomically on the data structures for a particular remote control session avoids potential race conditions.

Further, in the above example angled brackets (‘<’ and ‘>’) are used to indicate a description of the relevant data items—and in actual keys the ‘<’ and ‘>’ characters need not appear. For example an actual RCS metadata hash key of the example described above may be:
remote:{8b5d638d-2858-4a69-8430-5ca03235768e}: metadata

Further, while specific key and value formats have been described above alternative key/value formats are possible.

During a RCS, a presenter client application 132 stores local RCS data (e.g. in volatile memory 208 and/or non-transient memory 210 of the presenter client system 130). In the present embodiments, the local presenter RCS data includes the RCS ID and the data items defined in the RemotePresenterSessionInfo message (as described below in the example data specification, namely a count of connected presenters; a count of connected remote controllers; a session expiry timestamp; the RC link (discussed further below) and an initial state indicator), the page identifier of the presentable page currently displayed, and the current RCS state. The Local RCS data stored by a presenter client application 132 may be stored in any appropriate format.

Similarly, while a remote controller RCA 142 is connected to a RCS as a remote controller, it stores local RCS data (e.g. in volatile memory 208 and/or non-transient memory 210 of the remote controller client system 140). In the present embodiments, the local remote controller RCS data includes: the RCS ID; a current controller count; the current RCS state; a page identifier of the current presentable page; and the total number of pages in the presentable. In the embodiments described below, the RCA 142 receives the total number of presentable pages and current page in each state update message that updates the RCS state to enabled and receives a current presentable page in each page navigation command. The local RCS data stored by a remote controller client application 142 may be stored in any appropriate format.

The embodiments described below involve communications between presenter client applications 132 and server application 114 and between remote controller client applications 142 and server application 114. Communications from a client application 132/142 to the server application 144 will include or be associated with a user identifier (referred to as a presenter ID or remote controller ID as relevant). In certain implementations, a given user identifier may allow the user's system to be identified—e.g. a presenter user ID allows the presenter computer system 130 (on which the presenter client application 132 is running) to be identified and a remote controller user ID allows the remote controller computer system 140 (on which the remote controller RCA 142 is running) to be identified. Such identifiers can be generated in various ways, for example by generating and using a CDI (e.g. a device ID Cookie) as part of (or the) user identifier. Where a user accesses server application 114 by a user account their user ID may (additionally or alternatively) include a user account identifier.

### Presenter-Related Operations

This section describes remote control session (RCS) operations that involve the presenter client application (PCA) 132.

In the present examples, a PCA 132 causes a presentation user interface (UI) to be displayed on a display (e.g. 218) of the presenter's client system 130 (PCS 130). Generally speaking, the presentation UI may allow the presenter to search for/find/import a presentable, display a selected presentable, start a presentation that is associated with the selected presentable, invite audience members to join a presentation, and/or perform other presentation related operations, including those described below.

FIG. 17 provides one example of a presentation UI 1700 that may be displayed by the PCA 132 on a presenter's client system 130. Example UI 1700 includes: a presentable display area 1702 (for displaying pages of a presentable (e.g. a presentation document)), a start presentation control 1704, a create RCS control 1706, two page navigation controls (in this case a next page control 1708 and a previous page control 1710), and an effect control 1712 (which may be used to identify and play/activate a particular presentation effect, for example via a sub-menu such as that shown in FIG. 21).

### Presenter: Starting a Presentation and Remote Control Session

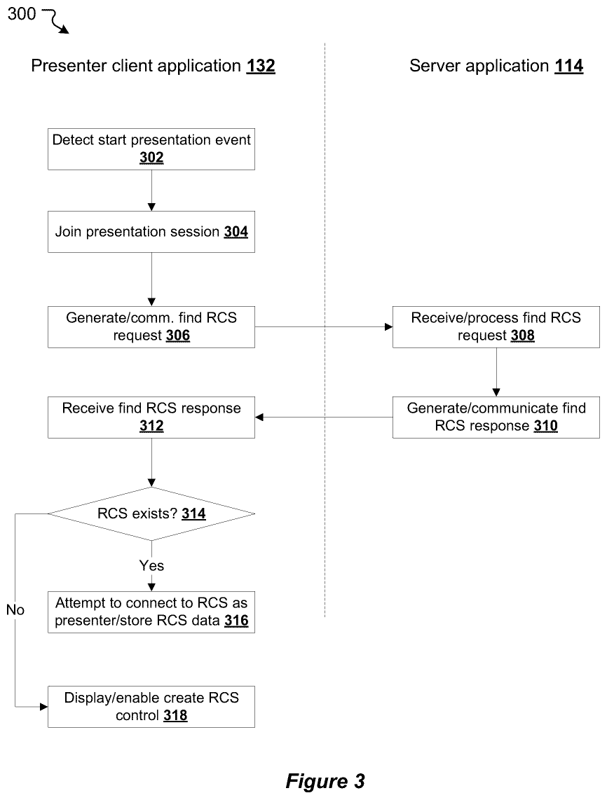

Operations performed to start a presentation and associated RCS will be described with reference to process 300 of FIG. 3.

At 302, PCA 132 detects a start presentation event. The start presentation event may be triggered in various ways. For example, a presenter may interact with a start presentation mode control (such as control 1704) displayed in the presentation UI. Following activation of the start presentation mode control 1704, PCA 132 may hide this control or convert it into a stop presentation control (e.g. control 1802 of FIG. 18).

At 304, in response to detecting the start presentation event, the PCA 132 joins a presentation session. This may initially involve establishing the presentation session if one does not already exist. Generally speaking, the presentation session is a session that allows the presenter (via their PCA 132) to deliver a presentation to audience members (who receive presentation data at their AM client applications 142 and view/listen to the presentation on their AM client systems 150). For example, via the presentation session the current page of the presentable that is displayed by the presenter's PCA 132 is displayed by AM client applications 152 that are connected to the presentation session. When the page changes at the presenter's client application 132—e.g. due to a page navigation command issued by the presenter or (as discussed below) a remote control page navigation command—the new page is displayed at the presenter's client application 132 and (via the presentation session) caused to be displayed by AM client applications 152 connected to the presentation session. Similarly, audio signals received by a microphone of the presenter's client system 130) may be sent to connected AM client applications 152 to be replayed (in real time) by AM client systems 150.

Establishing (and then joining) a presentation session will involve various operations performed by the PCA 132 and server application 114. One approach for establishing a presentation session to which a presenter and participants (e.g. audience members) can connect to is described in PCT/AU2021/050501. Presentation sessions may, however, be established and managed in alternative ways.

In the present embodiment, in response to detecting the start presentation event the PCA 132 also performs operations to determine whether a RCS has already been created for the presentation (and, if so, to connect to that RCS). This may be the case where the presenter has previously created a RCS for the presentable in question in preparation of the presentation.

At 306, PCA 132 generates a find RCS request and communicates it to the server application 114. The find RCS request is associated with (or will include) the presenter's user ID (as discussed above) and includes an identifier of a presentable (e.g. a presentable that the presenter has selected and is displayed in the presentation UI). In the example data specification below, the “rpc findRemoteSession” and associated data structures provide an example find RCS request format.

At 308, server application 114 receives the find RCS request.

At 310, in response to receiving the find RCS request, server application 114 generates a find RCS response.

In order to generate the find RCS response, server application 114 initially determines if a RCS already exists for the user ID associated with the request and the presentable identified in the request. To determine whether a RCS already exists, server application 114 queries the IMDB 116.

With the example RCS data described above, server application 114 determines if a RCS exists by determining if the user ID associated with the find RCS request and the presentable ID included in the RCS request identify/return a RCS ID—e.g., by a Redis command such as:
GET remote:user:<userID>:presentable:<presentable ID>

If a relevant RCS exists, this command will return a RCS ID. Otherwise no result will be returned.

If the RCS does exist server application 114 uses the RCS ID to retrieve further RCS data from the IMDB 116 which is used to generate the find RCS response. In the present example, this includes retrieving: the current value of the RCS presenter count; the current value of the RCS controller count; an expiry time for the RCS; a RC link (discussed further below); and state data (e.g. a flag indicating whether remote control is currently enabled or disabled for the RCS).

In the present example, the RC link is a URL that can be provided to and followed by remote controller to load a remote control page (discussed further below) and connect the remote controller to the intended RCS. By way of example, the remote control link may take a form such as:
<host>/presentation/remote?id=<token>

The remote control link includes a token, which in the present example is the unique RCS ID for the RCS. The token may, however, be any value that can be resolved/mapped to the RCS ID.

Where the RCS does not exist, the find RCS response may be empty (or include a defined value indicating that the RCS does not exist).

In the example data specification below, the “message FindRemoteSessionResponse” and associated data structures provide an example find RCS response format.

At 312, PCA 132 receives the find RCS response.

At 314, PCA 132 determines whether the find RCS response indicates that the RCS in question exists (in which case processing proceeds to 316) or not (in which case processing proceeds to 318).

At 316, a RCS exists. In this case PCA 132 attempts to connect to the RCS as a presenter (for example per process 500 described below). In addition, PCA 132 stores the find RCS response (or, at least, relevant data therefrom) as local RCS data on locally accessible memory—e.g. volatile memory 208 of the PCS 130.

At 318, no RCS exists. In the present embodiment, if no RCS exists PCA 132 displays (if not already displayed) and/or enables (if not already enabled) a create RCS control (e.g. 1708) in the presentation user interface. Activation of the create RCS control causes PCA 132 to attempt to create a RCS for the presentation and connect to that RCS (e.g. per process 400 described below).

In alternative embodiments, if a RCS does not exist, PCA 132 may automatically attempt to create a RCS for the presentation.

### Presenter: Creating a Remote Control Session

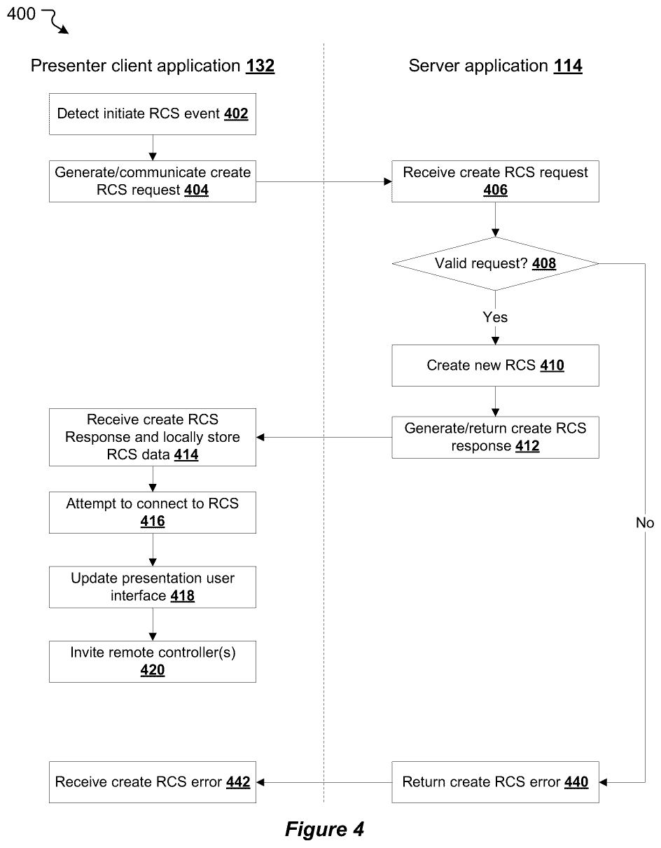

Turning to FIG. 4, a process 400 for creating a new remote control session (RCS) will be described.

At 402, PCA 132 detects an initiate RCS event. Various initiate RCS events are possible. For example, an initiate RCS event may be detecting user activation of a create RCS control (such as 1708). Alternatively, an initiate RCS event may be automatically triggered when a presentation is started (and a RCS does not already exist)—e.g. following operation 312 above.

At 404, in response to detecting the initiate RCS event, PCA 132 generates a create RCS request and communicates this to the server application 114. In the present embodiment, the create RCS request is associated with a presenter user ID and includes a presentable identifier (identifying the presentable that is to be presented—e.g. the presentable currently displayed in presentation interface 1700 or otherwise selected by a user of PCA 132). In the example data specification below, the “rpc createRemoteSession” and associated data structures provide an example create RCS request format.

At 406, the server application 114 receives the create RCS request.

At 408, the server application 114 determines if the create RCS request is valid. If so, processing proceeds to 410 and if not to 440.

In the present embodiment, server application 114 determines that the create RCS request is valid if the user ID associated with the request has permission to access the presentable identified in the request and no RCS already exists for the presentable identified in the request. If the user ID does not have permission to access the presentable, or an RCS has already been created for the presentable, server application 114 determines that the create RCS request is not valid.

Server application 114 may check whether the user ID has permission to access the presentable in a normal way—e.g. by querying a permissions service or otherwise checking permissions data associated with the presentable.

Server application 114 may, for example, determine whether a RCS associated with the user ID and presentable already exists as described above with reference to 310.

At 410, the create RCS request is valid. In this case, server application 114 creates a new RCS. Server application 114 creates a new RCS by generating relevant RCS data.

Initially, server application 114 generates a RCS ID for the new RCS. Any unique identifier may be generated/used. By way of example, server application 114 may generate the RCS ID by execution of a command such as UUID.randomUUID().toString.

Server application 114 also determines an expiry time for the new RCS. Any appropriate expiry time may be set, for example a default period following creation of the RCS (e.g. 3 hours, 6 hours, 12 hours, or any other period). In the present embodiments, RCS expiry is managed using both a hard cap value and a soft cap value. When a presenter connects to a RCS, the server application 114 sets the current expiry time of the Redis data structures to the hard cap. When a presenter disconnects from a RCS before the soft cap, the server application 114 sets the expiry time of the Redis data structures to whichever is smaller between the soft cap and the current (e.g. disconnection) time plus a grace period. When a presenter disconnects from the session after the soft cap, the server application 114 deletes the RCS. If a presenter stays connected beyond the hard cap, the server application 114 deletes the RCS. The soft cap, hard cap and grace period are retrieved by the server application 114 at execution time when they are relevant. The soft cap, hard cap, and grace period may have any appropriate default values, for example: soft cap=6 hours, hard cap=24 hours, grace period=1 hour. In some implementations these default values may be overridden by a dynamic configuration setup (dynamic configuration variables being stored, for example, on an external service and fetched as required).

Further, and with the example RCS data described above, server application 114 instantiates a state stream, page navigation commands stream, RCS identifier string, RCS metadata hash, RCS controller count string, and RCS presenter count string for the new RCS as follows:

| Data | Initialisation comment |
|---|---|
| State | In the present example, two dummy state records are generated |
| commands | and added to the state stream: an enabled state record (setting an |
| | ENABLED state) followed by a presenter disconnected state |
| | record. This is done to make initial connection with a RCS by the |
| | presenter functionally identical to reconnection to an ongoing RCS. |
| Page | In the present example, a dummy page navigation command |
| navigation | record is generated and added to this stream. The dummy record |
| commands | defines a default page index (e.g. 0 or, in embodiments where a |
| | presentable includes multiple documents, (0, 0)). The specific |
| | default page index does not matter, however, as it will be |
| | overwritten upon the presenter connecting to the RCS, and if a |
| | remote controller somehow manages to connect before the |
| | presenter the RCS will be set to a disabled state anyway (due to |
| | the presenter disconnected state record). |
| RCS ID | The RCS ID generated for the RCS |
| RCS | remote_control_id = RCS ID generated for the RCS identifier string. |
| metadata | presenter_user = user ID associated with the create RCS request. |
| | presentable = presentable ID included in the RCS request. |
| | start_timestamp = a timestamp of the session start time (e.g. the |
| | time the RCS metadata hash is generated/stored). |
| RCS controller | The RCS controller count is initialised to 0. |
| count | |
| RCS presenter | The RCS presenter count is initialised to 0. |
| count | |

At 412, the server application 114 generates a create RCS response and communicates this to the PCA 132. The RCS response includes connection information that allows a user (via a PCA 132) to connect to the RCS. In the present example, the create RCS response includes the following RCS data: the RCS ID; the current value of the RCS presenter count (which on creation of a RCS will be 0); the current value of the RCS controller count (which on creation of a RCS will be 0); the expiry time for the RCS; an RC link (as discussed above); and a flag indicating whether remote control is enabled or disabled for the RCS (which, on creation of a RCS, will indicate that remote control is disabled due to the presenter disconnected state). In the example data specification below, the “message CreateRemoteSessionResponse” and associated data structures provide an example create RCS response format.

At 414, the PCA 132 receives the create RCS response from the server application 114. On receipt, PCA 132 stores the create RCS response (or, at least, relevant data therefrom) as local presenter RCS data on locally accessible memory—e.g. volatile memory 208 of the client system 130.

In the present embodiment, at 416, in response to receiving the RCS response, PCA 132 automatically attempts to connect to the RCS as a presenter—for example as described in process 500 below.

At 418, following receipt of the RCS response, the PCA 132 may also update the presentation user interface (e.g. 1700) in light of the newly created RCS. By way of example, and with reference to FIG. 18, this may involve updating presentation UI 1700 to display one or more of: a stop presentation control 1802; an end RCS control 1804; an invite remote controller control 1806; a change state RC control 1808; a RCS state indicator 1810, and an invite audience member control 1812.

When activated, the invite remote controller control 1806 may launch an invite remote controller interface via which the presenter can select other users (e.g. by user ID, name, email address, or other identifier) and automatically generate communications (e.g. emails, instant messages, or other communications) to those users that include connection information (such as the RC link). Alternatively, or in addition, an invite remote controller control may, on activation, cause connection information (e.g. the RC link) to be copied to a clipboard. The presenter can then copy the connection information into manually generated communications to send to desired remote controllers.

The invite remote controller control 1806 is separate to an invite audience member control 1812. The invite audience member control 1812 may operate in a similar manner to invite remote controller control 1806 (e.g. by allowing a presenter to select and invite users to the presentation as audience members). Users invited as audience members are not, however, provided the RS connection information and as such are not able to remotely control the presentation.

The RCS state indicator 1810 includes a state indicator (which displays the current state of the RCS—e.g. enabled, disabled, presenter disconnected) and a connected controllers indicator (which displays the current number of connected remote controllers).

At 420, the presenter invites one or more other users to connect to the RCS as remote controllers. Generally speaking, inviting another user to connect to the RCS as a remote controller involves generating an RC invitation request communicating this to the other user. The RC invitation request includes remote controller connection data that is useable by a RC client application 142 to connect to the RCS—for example the RC link as described above and/or an alternative identifier that resolves to the identifier of the RCS in question. The RC invitation request may be communicated to the other user's client application 142 (either directly or via server application 114). Alternatively, the RC invitation request may be communicated by an alternative communication channel—for example using an email address of the other user, an instant messaging identifier for the other user, a phone number of the other user, or via an alternative identifier/communication channel. Inviting another user to connect as a remote controller may be initiated by interacting with an invite remote controller UI control as described above. While operation 420 is depicted as being performed by PCA 132 it may be performed by any appropriate application. For example a user of PCA 132 may copy the RC link (and/or other connection information) received at 414 and invite other users by sending the RC to one or more other users via email, instant message, or any other appropriate communication method.

At 440, the create RCS request is not valid. In this case, server application 114 returns an error to the PCA 132. The error indicates to the PCA 132 that the create RCS request is invalid and may, for example, be a 403/ForbiddenException (or any other appropriate create RCS error message/value).

At 442, the PCA 132 receives the create RCS error. Receipt of the create RCS error may indicate that there has been a connection dropout from an existing RCS or that an RCS already exists for the presenter and presentable in question. Various actions are possible on receipt of a create RCS error. For example, in response to receiving a create RCS error, PCA 132 may automatically attempt to find and connect to an existing RCS (e.g. by generating a find RCS request and communicating this to the server application 114 as described at 306 of FIG. 3).

Alternatively, receipt of the create RCS error may indicate that the user ID associated with the create RCS request does not have permission to access the presentable identified in the request. In this case, PCA 132 may display an alert indicating this.

### Presenter: Connecting to a Remote Control Session as a Presenter

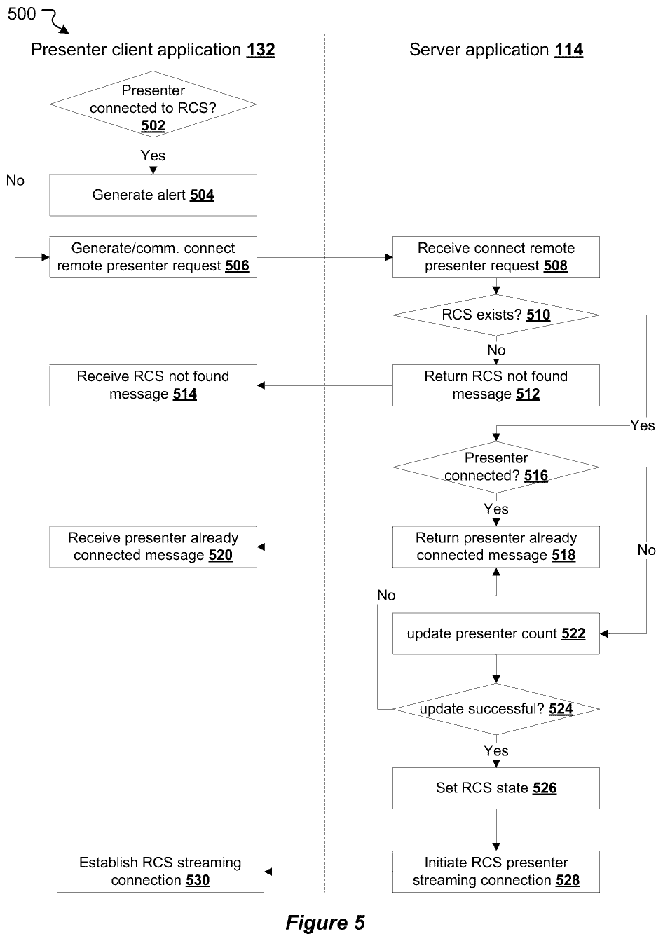

Once a presenter has RCS data (e.g. received at 312 of process 300 or 414 of process 400 above), the presenter's PCA 132 can connect to that RCS. This is described with reference to process 500 of FIG. 5. PCA 132 may be configured to perform process 500 automatically, for example following an existing RCS being found (e.g. at 316 above) or creation of a new RCS (e.g. at 416 above).

At 502, PCA 132 determines if a presenter is already connected to the RCS in question. This may be determined, for example, by reference to the locally stored presenter count (e.g. returned in the create RCS response received at 414). If the presenter count is greater than 0 a presenter is already connected and processing proceeds to 504. Otherwise processing proceeds to 506.

At 504, a presenter is already connected to the RCS in question. In this case, PCA 132 does not attempt to connect to the RCS and instead generates an alert indicating that the presenter is already presenting on a different device (e.g. by displaying the alert on a display 218).

At 506, a presenter is not already connected to the RCS in question. In this case PCA 132 generates a connect remote presenter request and communicates it to the server application 114. The connect remote presenter request includes data required to connect to a RCS as the presenter, e.g. the RCS ID. In the present example, the connect remote presenter request also includes a current page index (indicating the page of the presentable currently displayed by the PCA 132 or, in embodiments where a presentable may include multiple documents, the particular document and page) and the maximum page number of that presentable. In the example data specification below, the “rpc connectRemotePresenter” and associated data structures provide an example connect remote presenter request format.

At 508, server application 114 receives the connect remote presenter request.

At 510, server application 114 determines if the RCS identified in the connect remote presenter request exists. With the example RCS data described above, server application 114 may determine if the RCS exists by, for example, attempting to retrieve the metadata for the RCS. E.g., by a Redis command such as:
HGET remote:{<RCS_ID>}:metadata

If RCS metadata is returned the RCS exists (and processing proceeds to 516) otherwise it does not (and processing proceeds to 512).

At 512, the RCS no longer exists. In this case, server application 114 returns a RCS not found message to the PCA 132. The RCS not found message may, for example, be a “Flux.error(NotFoundException)”.

At 514, the PCA 132 receives the RCS not found message and displays an appropriate alert (e.g. that the RCS no longer exists). In certain implementations, receipt of an RCS not found message may be an initiate RCS event (per 402 above), in response to which PCA 132 automatically attempt to create a new RCS (e.g. per 404 above). In alternative embodiments, on receipt of an RCS not found message PCA 132 may be configured to display a create RCS control (e.g. 1708), activation of which is an initiate RCS event (per 402 above).

At 516, the RCS identified in the connect remote presenter request still exists. In this case, server application 114 determines if the RCS already has a connected presenter. If a presenter is already connected to the RCS (i.e. the presenter count value returned is >0), processing proceeds to 518. Otherwise (i.e. the presenter count value=0), processing proceeds to 522.

At 518, the RCS already has a connected presenter. This can be handled in various ways. In the presently described embodiments, remote control sessions are configured to allow a single presenter only. In this case, if a presenter is already connected server application 114 returns a presenter already connected message to the PCA 132. The presenter already connected message may, for example, be a “Flux.error(ForbiddenException)”.

At 520, the PCA 132 receives the presenter already connected message and displays an appropriate alert. This may, for example, be an alert that a presenter is already connected to the RCS, e.g. via a different device/client application. In some embodiments, such an alert may be accompanied by an option allowing the user to cancel the existing presenter connection with the RCS and establish a new connection. If this option is taken, an appropriate message is communicated to the server application 114 which then performs operations to cancel the existing presenter connection and establish a new presenter connection.

In alternative implementations, remote control sessions may be configured to permit multiple presenters (and/or the same presenter presenting on multiple devices). In this case a presenter already being connected need not trigger an error (or necessarily require disconnection of the existing presenter/overwriting the current state variables for the RCS).

At 522, the RCS exists and does not already have a connected presenter. In this case, server application 114 updates (e.g. increments) the presenter count. With the example RCS data described above this can be done by updating the RCS presenter count, e.g. by a Redis command such as:
INCR remote:{<RCS_ID>}:presentercount

Server application 114 may be configured to perform additional checks before updating the presenter count at 522, and only update the presenter count if those checks are passed. For example, server application 114 may initially check that the relevant key actually exists (and if it does not return an error). Server application 114 may also check that incrementing the presenter count will not result in it exceeding an upper limit (e.g. 1), which may occur if multiple users are attempting to connect to the same RCS as presenters at the same (or substantially the same) time. In the Redis example, additional checks such as this (and a conditional increment) may be performed using the EVAL command with a script defining the check(s) to be evaluated.

At 524, server application 124 determines if updating the presenter count at 522 was successful or not. If the update was not successful (e.g. due to the key not existing or incrementing the presenter count would exceed a maximum presenter count value) processing returns to 518. Otherwise processing proceeds to 526.

At 526, only one presenter is currently connected to the RCS. In this case server application 114 determines and sets a state of the RCS.

In the present example, this involves the server application 114 determining a current state. The current state is the state defined by the most recent state record in the state stream that defines a state other than ‘presenter disconnected’. The server application 114 then generates a new state record corresponding to the current state and saves this to the state stream.

For example, if the most recent non-presenter disconnected state record is a disabled state record, server application 114 generates a new state disabled record and saves this to the state stream. Conversely, if the most recent non-presenter disconnected state record is an enabled state record, server application 114 generates a new state enabled record and saves this to the state stream. In this case, the current page included in the new state enabled record is the page index defined in the connect remote presenter request.

If the connect remote presenter request received at 508 is the first time the presenter has connected to the RCS, the most recent state record will be an enabled state record (as generated at 410).

Following 526, the server application 114 and PCA 132 establish a presenter connection (i.e. a data connection for communicating RCS data between the PCA 132 and server application 114). In the present embodiments the presenter connection is a streaming connection established at 528 and 530.

At 528, server application 114 initiates a RCS presenter streaming connection (e.g. an outgoing stream) with the presenter's PCA 132. The RCS presenter streaming connection may be an RSocket channel. The RCS presenter streaming connection may be initialised with an expiry time, for example 24 hours from creation (or from when a presenter subscribes to the RCS streaming connection).

As described in further detail below, while a RCS is active, server application 114 periodically retrieves state and RC command messages from the IMDB 116 (in particular from the RCS page navigation commands stream(s) and RCS state stream) and communicates those messages (or data based thereon) to the presenter's PCA 132 over the RCS presenter streaming connection. This can be achieved in various ways. For example, server application 114 may create a presenter sink (e.g. using the Flux.create command), associate this with the presenter streaming connection, write relevant messages/data to the sink, then stream data from the sink to the PCA 132.

To initiate the RCS presenter streaming connection, server application 114 returns RCS streaming connection data to the presenter's client application. The RCS streaming connection data allows the PCA 132 to subscribe to the RCS presenter streaming connection.

At 530, PCA 132 receives the RCS streaming connection data and establishes the RCS presenter streaming connection with the server application 114 (e.g. by subscribing to the RCS presenter streaming connection). In addition, PCA 132 locally stores data indicating that the current state of the RCS is enabled.

As described in further detail below with reference to FIGS. 14, 15, and 16, during a RCS the server application 114 periodically receives and processes remote presenter client synchronisation messages which cause RCS state records to be added to the RCS state stream and page navigation command records to be added to the RCS page navigation commands stream (and/or other remote control command records to be added to the relevant data structure). Server application 114 reads records from the RCS state stream and RCS page navigation commands stream, transforms them into remote presenter server synchronisation messages, and sends these to the presenter's PCA 132 over the streaming connection established at 528 and 530.

### Presenter: Enabling/Disabling Remote Control

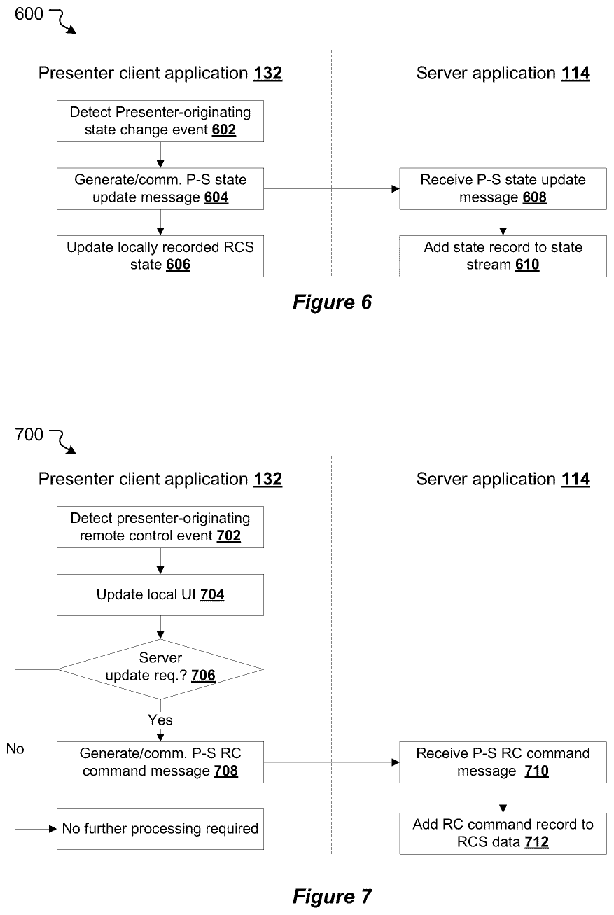

Once a RCS has been created, a presenter may (via their application 132) enable or disable remote control functionality for the RCS. This will be described with reference to state control process 600 of FIG. 6.

At 602, PCA 132 detects a presenter-originating RCS state change event. The presenter-originating RCS state change event may be triggered in various ways. For example, a presenter may interact with a change state control such as control 1808 of FIG. 18. In this example, the change state control 1808 is a switch: if the current state of the RCS is enabled, activation of control 1808 is a disable RC state change event; conversely, if the current state of the RCS is disabled, activation of control 1808 is an enable RC state change event.

At 604, in response to detecting the presenter-originating RCS state change event, PCA 132 generates a presenter-to-server (P-S) state update message and communicates it to the server application 114. In the present embodiment, the state update message is communicated over the RCS presenter streaming connection. In alternative embodiments, the PCA 132 (and server application 114) may be configured so that state update messages are communicated over a separate communication channel.

The type and content of the P-S state update message depends on the state change event that has been detected. If the state change event is an enable RC event, the message indicates that RC is to be enabled and also includes an identifier of the currently displayed presentable page (e.g. a page index) and the total number of pages in the presentable (e.g. a max page value). In the example data specification below, the “message RemotePresenterRemoteControlStateClientSync” and associated data structures provide example P-S state update message formats.

At 606, PCA 132 updates its local presenter RCS data to record the updated state of the RCS (e.g. to enabled or disabled, as per the state change event).

At 608, server application 114 receives the P-S state update message.

At 610, in response to receiving the P-S state update message, server application 114 generates a state record that reflects/includes the state data included in the state update message (e.g. an enabled state record or a disabled state record) and adds this to the state stream. In the context of the data specification example below, server application 114 adds a “RemoteControlEventRecord” containing a “RemoteControlStateCommandRecord” into the state stream.

The above example describes state change events that impact the RCS as a whole. As described above, however, in certain implementations an additional (or alternative) permissions mechanism may be provided in order to more granularly control (for example) which remote control operations are available to which users.

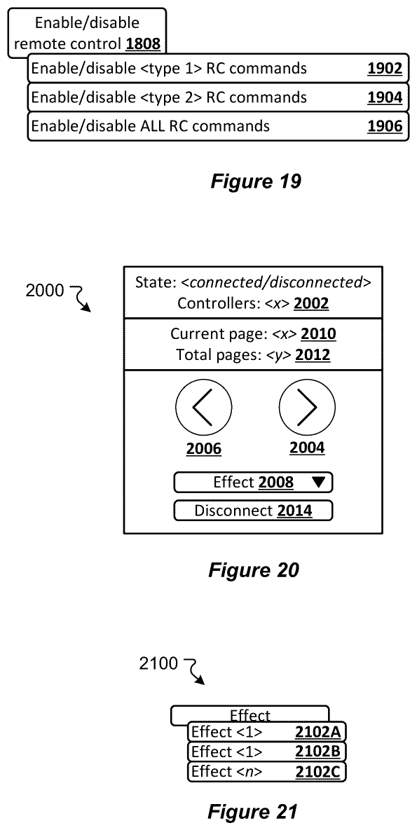

Consider, for example, a presentation platform that facilitates two different types of RC commands (e.g. page navigation RC commands and presentation effect RC commands). In this case, PCA 132 may provide UI controls to allow enabling/disabling of each different type of RC command independently. For example, activation of a state change control such as 1808 of FIG. 8 may launch a further menu which includes separate enable/disable controls for each different type of RC command (e.g. 1902 and 1904 of FIG. 19) as well as (in this case) a control 1906 for enabling/disabling all RC command types.

In addition, or alternatively, the presentation platform may allow a presenter (or other appropriately permissioned user) to enable/disable remote control commands or (all RC commands or specific RC commands) for specific remote controllers (or groups of remote controllers). In this case, PCA 132 may provide UI controls to allow enabling/disabling of RC commands (as a group or individually) for specific remote controllers that are connected to the RCS (or groups of remote controllers). For example, activation of a state change control such as 1808 of FIG. 8 may launch a further menu which includes enable/disable controls for each remote controller connected to the RCS (or remote controller groups).

In certain implementations, handling RC command-based and/or user-based permissions may be achieved through the state update mechanism described here. For example, the P-S state update message generated at 604 may include data indicating the specific type of RC command that has been enabled/disabled and/or the specific user (or user group/user role) RC command(s) have been enabled/disabled for. Similarly, at 610 server application 114 generates a state record to include data indicating the type of RC command that has been enabled/disabled and/or the user (or user/group/role). In alternative implementations, more granular permissions such as these may be facilitated by a separate permissions mechanism, which may operate in a similar manner to the state update mechanism described.

Further, where RC command permissions are handled on a command type-basis and/or user-basis, instead of displaying an overall RCS state, a RCS state indicator (such as 1810) may display (or be operable to display) which types of RC commands are currently enabled/disabled and for which users/user groups.

In the present examples, the presenter-to-server (P-S) state update message generated at 604 includes a page index value that identifies the currently displayed presentable page (or document and page). Given this, and as discussed further below, in certain embodiments the state update message may be used to communicate page navigation events to connected remote controller client applications 142. In such embodiments, the presenter client application 142 may be configured so that changing the currently displayed page of the presentable is a state change event—e.g. a page update state change event (which is detected at 602 and causes generation/communication of a state update message at 604). Changing the currently displayed page of the presentable may be a state change event whether the page update is initiated by the presenter client application 132 itself (e.g. as described below with reference to FIG. 7) or initiated by a remote controller client application 142 (e.g. in response to receiving and processing a server-to-presenter page navigation command received while the remote control session state is enabled).

### Presenter: Presenter-Originating Remote Control Events

While a RCS is active, a presenter may (via PCA 132) initiate events that are remote control events. For example, a presenter may navigate through pages of the presentable that the RCS is associated with and is displayed at the presenter's device 130.

The operations performed when a presenter initiates a remote control event will be described with reference to process 700 of FIG. 7.

At 702, PCA 132 detects a presenter-originating RC event.

At 704, in response to detecting the presenter-originating RC event, PCA 132 updates the presentation UI in accordance with the event.

At 706, PCA 132 determines whether a server update is required for the presenter-originating RC event. This will depend on the type of the event (examples provided below). If a server update is required, processing proceeds to 708. If not, no further action is required by the PCA 132 to process the event.

At 708, PCA 132 generates a presenter-to-server RC command message (P-S RC command message for short) and communicates it to the server application 114. The message includes data in respect of the RC event that has been detected. In the present embodiment, the RC command message is communicated over the RCS presenter streaming connection. In alternative embodiments, the PCA 132 (and server application 114) may be configured so that state update messages are communicated over a separate communication channel.

At 710, server application 114 receives the P-S RC command message.

At 712, in response to receiving the P-S RC command message, server application 114 generates a RC command record and adds it to the relevant RCS data structure. The type of RC command record (and data defined therein) and the relevant RCS data structure will depend on the type of command defined in the P-S RC command message.

To illustrate process 700, consider a page navigation type RC event. A presenter-originating page navigation event may be triggered (and detected at 702) in various ways. For example, a presenter may interact with a page navigation control displayed at client system 130 (e.g. next/previous page control 1710 and 1712). As a further example, a presenter may have configured application 132 to automatically navigate between presentable pages—e.g. based on set page transition times or delays.

For a page navigation type RC event, PCA 132 will update (at 704) the presentation UI to display the page of the presentable that has been navigated to by the navigation event. The displayed page will be associated with a page identifier (e.g. a page index or other identifier and, if necessary, a document identifier).

For a page navigation type RC event, a server update is required. In the present embodiment, the P-S RC command message generated at 708 will indicate that the type of event is a page navigation event and include the identifier of the presentable page that has been navigated to. In the example data specification below, the “RemotePresenterPageNavigationClientSyncMessage” provides an example P-S page navigation message format.

For a page navigation type RC event, and with the example RCS data described above, server application 114 generates a new RCS page navigation command record at 712 that includes the page ID included in the received message and adds this to the page navigation commands stream. In the context of the data specification example below, server application 114 adds a “RemoteControlEventRecord” containing a “message PageNavigationCommandRecord” into the page navigation commands stream.

As described above with reference to FIG. 6, the presenter-to-server (P-S) state update message also (in the present examples) includes a page index field (identifying the currently displayed presentable page and, if necessary, document). In alternative embodiments, and as described further below, the P-S RC command message generated by the presenter client application 132 in response to a page navigation type RC event may be a state update message that includes the new current page of the presentable (i.e. after the presenter client application 132 has updated the current page in accordance with the page navigation command).

As a further example, consider a presentation effect type RC event triggered at 702, for example, by PCA 132 detecting activation of a presentation effect control such as 1712. On detection of the presentation effect type RC event, PCA 132 causes the particular event in question to display or play at 704. Unlike a page navigation type RC event, however, a presentation effect type RC event does not require a server update. This is determined at 706 and processing for the presentation effect type RC event is complete (from a RCS perspective).

In addition to the operations performed in association with the RCS, a presenter-originating RC event will also impact the presentation session itself. For example, where a presenter changes the presentable page that is currently displayed, this will cause the presentable page as displayed by any connected audience member client application 152 to be updated accordingly. Similarly, where a presenter activates a particular presentation effect (e.g. a confetti shower), that effect will be played at any connected audience member client application 152.

### Presenter: Processing Stream Messages

While a RCS is active, a presenter's PCA 132 will receive messages from server application 114 over the RCS presenter streaming connection. These will be referred to as server-to-presenter (S-P) stream messages. Generation and communication of S-P stream messages by server application 114 is described below with reference to FIGS. 14, 15, and 16. Processing S-P stream messages by a presenter's PCA 132 will be described with reference to process 800 of FIG. 8.

At 802, the presenter's PCA 132 receives a S-P stream message.

At 804, PCA 132 determines a type of the S-P stream message. In the present embodiment, the received message is either a S-P controller count update message or a S-P RC command message.

If the stream message received at 802 is a controller count update message processing proceeds to 806. In this case the controller count update message includes a current number of remote controllers that are currently connected to the RCS. In the example data specification below, the “message RemotePresenterControllerCountServerSyncMessage” provides an example S-P controller count update message format.

At 806, PCA 132 updates the locally stored connected remote controller count. In the present embodiment, at 808 PCA 132 also updates the presentation interface to display the new number of connected remote controllers (for example in the RCS state indicator 1810).

If the stream message received at 802 is a S-P RC command message, processing proceeds to 810.

At 810, PCA 132 determines if the current state of the RCS is enabled. Where enabled/disabled states are handled on a RC command type basis, determining if the current state of the RCS is enabled involves determining if the current state of the RCS is enabled for the particular type of RC command defined by the S-P RC command message. PCA 132 determines the current state by checking the locally stored RCS state data (as stored, for example, at 606). If the RCS state is disabled (either generally or for the particular RC command type in question), the S-P RC command message is ignored (as indicated at 812). Otherwise, processing proceeds to 814.

At 814, PCA 132 determines if the command defined in the S-P RC command message is valid. This determination will depend on the type of command in question (see example below). If the command is not valid, the message is ignored (as indicated at 812). Otherwise processing proceeds to 816.

At 816, PCA 132 actions the command defined in the S-P RC command message. This too will depend on the type of command in question. Generally speaking, however, in order to action a particular RC command the PCA 132 may (if required) locally store relevant command data (in the local presenter RCS data) and update the presentation interface in accordance with the command.

Actioning the RC command also leads PCA 132 to perform additional actions associated with the presentation (but not the RCS specifically). For example, updating the presentation in accordance with the RC command will, via the underlying presentation mechanism, cause corresponding updates to be performed for all audience members that are connected to the presentation.

To illustrate process 800, consider a S-P RC command message that defines a page navigation command. This will be referred to as a S-P page navigation message. A S-P page navigation message will include a page identifier (e.g. a page index). In the example data specification below, the “message RemotePresenterPageNavigationServerSyncMessage” provides an example S-P page navigation message format.

For a S-P page navigation message, at 810 PCA 132 checks the locally stored RCS data to determine whether page navigation type RC commands are enabled (this may be due to a general enabled state for the RCS or a specific page navigation type RC commands enabled state). If page navigation type RC commands are disabled, the S-P page navigation message is ignored at 812.

If page navigation type RC commands are enabled, PCA 132 determines at 814 if the specific command is valid. For a page navigation type RC command this involves determining if the page identified in the message is a valid page. In the present example, if the page identified in the message is greater than the maximum page number of the presentable associated with the RCS, it is not a valid command and the S-P page navigation message is ignored (at 812).

If the page navigation type RC command is valid, the PCA 132 actions the command at 816. For a page navigation command this involves writing the page defined in the command to the locally stored RCS data (as the current page) and displaying the page of the presentable identified in the S-P page navigation message in the presentation user interface. In addition, updating the current page of the presentable will cause PCA 132 to perform additional operations associated with the presentation session more generally—e.g. to cause the presentable page as displayed by any connected audience member client application 152 to also update to the new current page.

As further illustration of process 800, consider a S-P RC command message that defines a presentation effect command. This will be referred to as a S-P presentation effect message. A S-P presentation effect message will include an effect identifier (e.g. a string, integer, or other identifier) which identifies a particular presentation effect. In the example data specification below, the “message RemotePresenterEffectServerSyncMessage” provides an example S-P presentation effect message format.

In the present example, all S-P effect messages are considered to be valid at 814 (provided the RC state is enabled). Accordingly, at 816 PCA 132 causes the effect defined in the S-P presentation effect message to be played/displayed. This causes that effect to also be played/displayed by any connected audience member client application(s) 152. Given the transient nature of presentation effects, PCA 132 does not need to update any locally stored RCS data to record the effect/S-P presentation effect message.

### Presenter: Disconnecting from a RCS

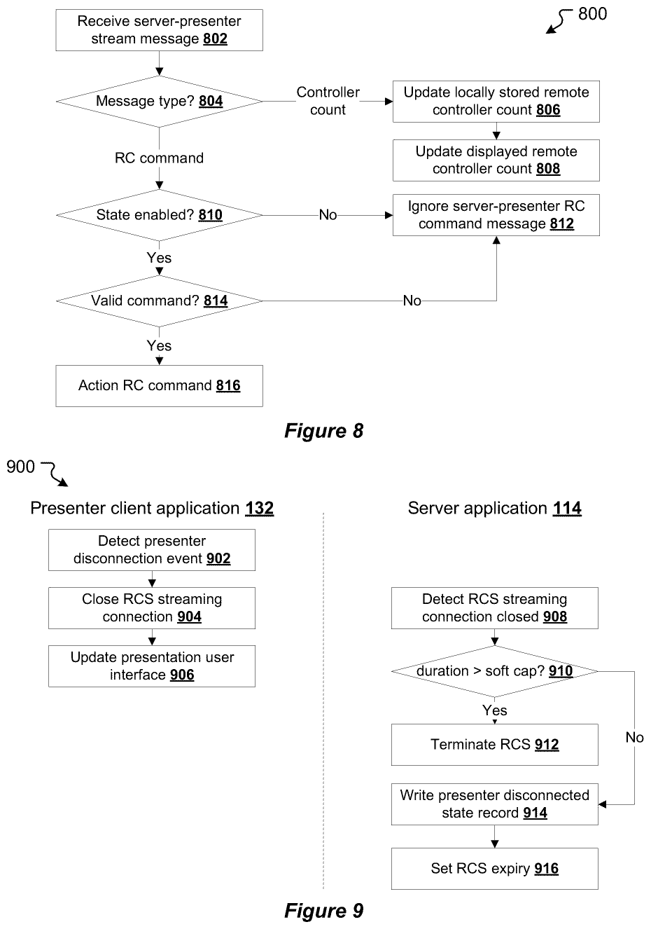

While a RCS is active, a presenter may (via their PCA 132) disconnect from the RCS. This will be described with reference to process 900 of FIG. 9.

At 902, PCA 132 detects a presenter disconnection event. The presenter disconnection event may be triggered in various ways. For example, a presenter may activate a ‘stop presentation’ or ‘end RCS’ type control (e.g. controls 1802 or 1804 of FIG. 18). Alternatively, PCA 132 may be configured such that a presenter disconnection event automatically occurs if no activity relating to the RCS/presentable associated therewith occurs within a defined disconnection period (e.g. 15 minutes, 30 minutes, or any other appropriate period).

At 904, if not already done, PCA 132 closes the RCS presenter streaming connection (e.g. closes the websocket).

The RCS remote controller streaming connection may be closed or terminated in other ways—for example by PCA 132 itself being closed (or crashing), client system 130 being shut down/put into a sleep mode, network connectivity being lost, and/or any other event causing termination of the streaming connection.

In addition, and if the presentation user interface is still displayed, at 906 PCA 132 updates the presentation user interface as appropriate. Generally speaking this involves ceasing to display user interface elements associated with the RCS—for example ceasing to display controls such as the RCS state indicator 1810 (or, at least, updating it to indicate a disconnected state), the invite remote controller control 1806, the enable/disable RC control 1808, and/or any other relevant UI elements that are no longer relevant once the PCA 132 has disconnected from the RCS.

At 908, server application 114 detects that the RCS presenter streaming connection with the presenter's PCA 132 has been closed.

In response to detecting that the RCS presenter streaming connection has been closed, server application 114 decrements the value stored by the RCS presenter count string (e.g. from 1 to 0).

At 910, server application 114 determines if the RCS duration exceeds the soft cap for the RCS. If the RCS has been running for longer than the soft cap, processing proceeds to 912. Otherwise, processing proceeds to 914.

At 912, server application 114 terminates the RCS. In the present embodiment, connections are closed on discovering that data structures in respect of the RCS no longer exist. In alternative embodiments, and if required, termination of the RCS may involve performing operations to delete the data associated with the RCS from the IMDB 116, for example by deleting all records that include the RCS ID of the RCS in question in either the key or value. In addition, server application 114 closes all RCS streaming connections that are currently open with remote controller client applications 142.

At 914, the soft cap for the RCS has not been exceeded. In this case, server application 114 generates a presenter disconnected state record and adds this to the state stream. In the context of the data specification example below, server application 114 adds a “RemoteControlEventRecord” containing a “RemoteControlStateCommandRecord” into the state stream. As discussed below with reference to FIG. 15, this will cause a state update message to be sent to client applications 142 of any connected remote controllers.

At 916, server application 114 sets an expiry time (or time period) for the RCS in question. In the present example, server application 114 sets the expiry time to be the earlier of a defined time period from presenter disconnection (e.g. 1 hour or an alternative time period) or the soft cap for the RCS (as described above).

### Remote Controller Related Operations

This section describes remote control session (RCS) operations that involve the remote controller client application (RCA) 142.

### Remote Controller: Connecting to a RCS as a Remote Controller

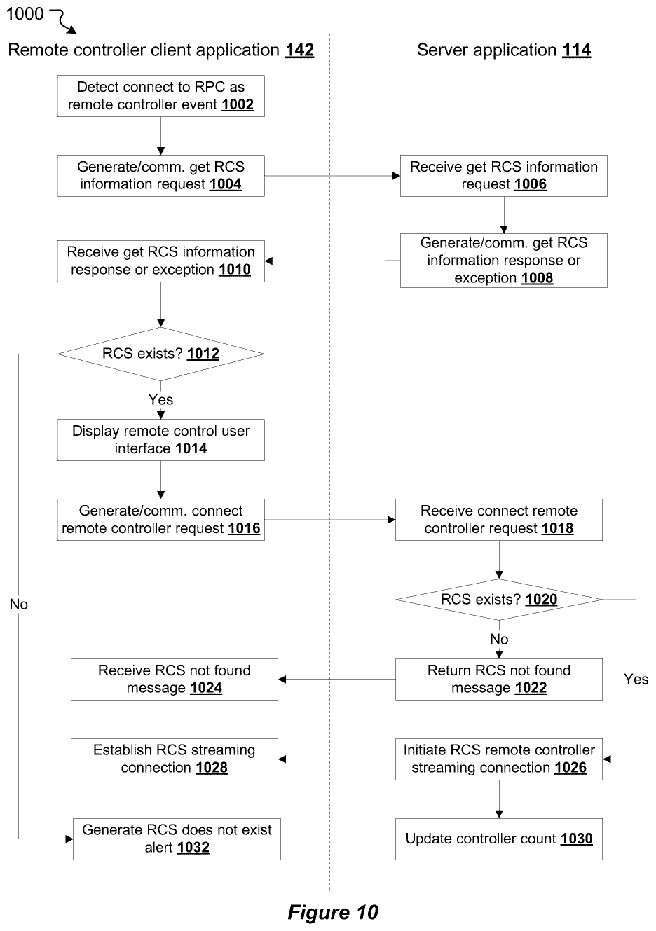

Once a RCS has been created, a user (referred to as a remote controller) may connect to the RCS to control the presentation via their remote controller RC client application (RCA) 142. Connecting to a RCS as a remote controller will be described with reference to process 1000 of FIG. 10.

At 1002, RCA 142 detects a connect to RCS as remote controller event. Various such events are possible, for example activation of an RC link that has been received at the remote controller's client system 140.

At 1004, in response to detecting the connect to RPC as remote controller event, RCA 142 generates a get RCS information request and communicates this to the server application 114. In the present embodiment, the get RCS information request includes the RCS ID (included, for example, as the token in the RC link), however any token or data which uniquely identifies an RCS may be included. In the example data specification below, the “rpc getRemoteControllerSessionInfo” and associated data structures provide an example get RCS information request format.

At 1006, server application 114 receives the get RCS information request.

At 1008, in response to receiving the get RCS information request, server application 114 generates a get RCS information response and communicates this to the RCA 142.

In order to generate the get RCS information response, server application 114 initially determines if a RCS associated with the RCS ID included in request exists. To do so server application 114 queries the IMDB 116. With the example RCS data described above, server application 114 may determine if a RCS exists by, for example, attempting to retrieve the metadata for the RCS—e.g. by a Redis command such as:
HGET remote:{<RCS_ID>}:metadata

If a relevant RCS exists, this command will return the RCS metadata. Otherwise no result will be returned. In the present embodiment, if the RCS does exist server application 114 also uses the RCS ID to retrieve the most recent state update for the RCS—e.g. by a Redis command such as:
XREVRANGE remote:{<RCS_ID>}:stream:state+−COUNT 1

Server application 114 also uses the RCS ID to retrieve the most recent page navigation command record (in this case from the page navigation command stream).

With this information, server application 114 generates the get RCS information response. In the present example, where the RCS exists the response includes the RCS ID, the most recent state update (or data therefrom), the current presentable page (from the more recent page navigation command record) and the controller count. Where the RCS does not exist, a 404/NotFoundException is generated (though an alternative error response indicating the RCS no longer exists may be generated). In the example data specification below, the “message GetRemoteControllerSessionInfoResponse” and associated data structures provide an example get RCS information response format.

At 1010, RCA 142 receives the get RCS information response (or, if generated, exception such as a 404/NotFoundException).

At 1012, RCA 142 determines whether the RCS in question exists (in which case processing proceeds to 1014) or not (in which case processing proceeds to 1032). In the present example, receipt of a get RCS information response indicates the RCS exists while an exception indicates it does not.

At 1014, the RCS in question exists. In this case RCA 142 displays a remote control user interface. The remote control user interface may be a web page or application page that is retrieved from a server of the server environment—e.g. server application 114 or an alternative server application. Alternatively, the remote control user interface may be generated based on data/instructions locally available to RCA 142 (e.g. as stored in volatile memory 208 or non-transient memory 210 of client system 140).

The remote control user interface will include one or more remote presentation controls. The precise controls that are provided (and enabled) will depend on the types of remote control commands that the presentation platform provides. FIG. 20 provides an example remote control UI 2000 which includes: a state indicator 2002 (which in this case indicates whether the remote controller is connected or not and a number of connected remote controllers); RC page navigation controls (in this case a next page control 2004 and a previous page control 2006); a RC effect control 2008; a current page indicator 2010 (indicating a current page of the presentation document); a maximum page indicator 2012 (indicating the total number of pages in the presentation document); and a disconnect control 2014. In the present example, activation of the RC effect control 2008 causes an effect selection menu 2100 to be displayed as shown in FIG. 21. The effect selection menu 2100 includes effect controls 2102 for the different types of effects that are facilitated by the presentation platform (in this example three effect controls 2102A-C).

At 1016, RCA 142 generates a connect remote controller request and communicates this to the server application 114. The connect remote controller request includes the RCS ID. In the example data specification below, the “rpc connectRemoteController” and associated data structures provide an example connect remote controller request format.

At 1018, server application 114 receives the connect remote controller request.

At 1020, server application 114 determines if the RCS identified in the connect remote controller request still exists. This may, for example, be done by determining if any RCS data associated with the RCS ID exist in the IMDB 116 (e.g., as one example, per 510 above). If the RCS no longer exists, processing proceeds to 1022. Otherwise processing proceeds to 1026.

At 1022, the RCS no longer exists. In this case, server application 114 returns a RCS not found message to the RCA 142. The RCS not found message may, for example, be a “Flux. error (NotFoundException)”.

At 1024, the RCA 142 receives the RCS not found message and displays an appropriate alert (e.g. that the RCS no longer exists).

If, at 1020, the RCS exists, the server application 114 and RCA 142 establish a remote controller connection (i.e. a data connection for communicating RCS data between the RCA 142 and server application 114). In the present embodiments the presenter connection is a streaming connection established at 528 and 530.

At 1026, server application 114 initiates a RCS remote controller streaming connection (e.g. an outgoing stream) with the remote controller's RCA 142. The RCS streaming connection may be an RSocket channel. To initiate the RCS streaming connection, server application 114 returns RCS streaming connection data to the presenter's client application. The RCS remote connection data allows the RCA 142 to subscribe to the RCS remote controller streaming connection.

As described in further detail below, while a RCS is active, server application 114 periodically retrieves state and RC command messages from the IMDB 116 (in particular from the RCS page navigation commands stream(s) and RCS state stream) and communicates those messages (or data based thereon) to the remote controller's RCA 142 over the RCS RC streaming connection. This can be achieved in various ways, for example by creation and use of a remote controller sink (similar to the presenter sink described above). At 1028, RCA 142 receives the RCS streaming connection data and establishes the RCS remote controller streaming connection with the server application 114 (e.g. by subscribing to the RCS remote controller streaming connection).

At 1030, once the streaming connection has been established, server application 114 updates (e.g. increments) the controller count. With the example RCS data described above this can be done, for example, by updating the RCS controller count, e.g. by a Redis command such as:
INCR remote:{<RCS_ID>}:controllercount

As described above with reference to updating the presenter count (at 522), server application 114 may be configured to perform additional checks before updating the controller count at 1030 (e.g. ensuring the relevant key exists and/or that updating the controller count will not result in an impermissible controller count value (e.g. greater than a maximum controller count value if a maximum is implemented)).

On establishment of the RCS remote controller streaming connection, server application 114 retrieves certain RCS data and communicates this to the RCA 142 (either over the streaming connection or by separate message/communication). In the present embodiment this includes: the page identified in the most recent page navigation command record; the maximum page number; the current state of the RPC (e.g. enabled, disabled, presenter disconnected). On receiving this data, RCA 142 locally stores it (e.g. in volatile memory 208 and/or non-transient memory 210). In the present example, RCA 142 also updates the remote control user interface to indicate that the RCA 142 is connected as a remote controller and to indicate the number of remote controllers connected to the RCA (e.g. by updating state indicator 2002).

At 1032, the RCS no longer exists. In this case RCA 142 displays an error message (or error page) alerting the user to this.

### Remote Controller: Controller-Originating Remote Control Events

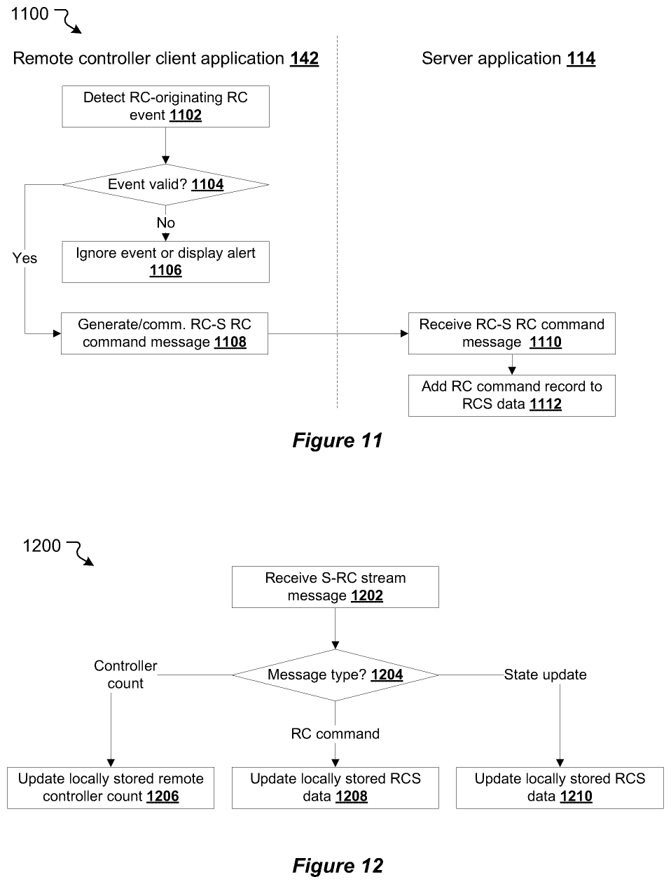

While a RCS is active, a remote controller may (via the remote control UI 2000) issue remote control commands. The operations performed when a remote controller does so will be described with reference to process 1100 of FIG. 11.

At 1102, RCA 142 detects a remote controller-originating (RC-originating) RC event. In the present example, a RC-originating RC event is triggered via user interaction with a UI control provided in the remote control UI 2000.

At 1104, RCA 142 determines if the RC-originating RC event is valid.

In part, determining if a RC-originating RC event is valid involves RCA 142 checking the remote controller's local RCS data to determine if the current state of the RCS is enabled. Where enabled/disabled states are handled on a RC command type basis, determining if the current state of the RCS is enabled involves determining if the current state of the RCS is enabled for the particular type of RC command in question. If the RCS state is disabled (either generally or for the particular RC event in question), the RC-originating event is not valid and processing proceeds to 1106. Otherwise, processing proceeds to 1108.

In some implementations, RCA 142 may be configured to disable (e.g. by displaying in a greyed-out or other manner) or not display UI controls that relate to command types that are not currently enabled. For example, if a RCA 142 is connected to a RCS but page navigation commands have been disabled, RCA 142 may either display page navigation controls 2004/2006 in a disabled state (so they cannot be activated yet provide a user with feedback that page navigation controls are disabled) or not display page navigation controls 2004/2006 at all.

In order to determine if a RC-originating RC event is valid, RCA 142 may also perform additional checks based on the type of RC event in question. For example, and as discussed below, for a RC-originating page navigation event the RCA 142 will check if the event would cause navigation to a non-existent page of the presentable associated with the RCA (in which case the event would be invalid at 1104).

At 1106, the event is not valid. In this case, RCA 142 may be configured to ignore the event entirely or to display an alert (e.g. “Remote control disabled”, “invalid page”, or other message appropriate to the cause of the event being invalid) in the remote control user interface.

At 1108, RCA 142 generates a remote controller-to-server (RC-S) RC command message and communicates it to the server application 114. In the present embodiment, the RC command message is communicated over the RCS remote controller streaming connection. In alternative embodiments, the RCA 142 (and server application 114) may be configured so that these are communicated over a separate communication channel. The message includes data in respect of the RC event in question. In the example data specification below, the “message RemoteControllerClientSyncMessage” and associated data structures provide an example RC-S RC command message format.

At 1110, server application 114 receives the RC-S RC command message.

At 1112, in response to receiving the RC-S RC command message, server application 114 generates a RC command record and adds it to the relevant RCS data structure (for example as described at operation 712 above).

To illustrate process 1100, consider a page navigation type RC event. A RC-originating page navigation event may be triggered (and detected at 1102) by user activation of a RC page navigation control in the remote control UI (e.g. next/previous page control 2004/2006).

For a RC-originating page navigation event, RCA 142 determines if the event is valid at 1104 determining if RC page navigation commands are enabled for the RCS (by checking the RCS data locally stored at the remote controller system 140) and whether the command would result in navigation to a non-existent page of the presentable associated with the RCS. RCA 142 makes this determination with reference to the locally stored current page and maximum page values. For example, activation of a previous page control when the current page of the presentable is page 0 will be an invalid page navigation event. Similarly, activation of a next page control when the current page of the presentable is equal to the maximum page number associated with the presentable will be an invalid page navigation event.

If the page navigation event is valid, RCA 142 generates a RC-S page navigation message and communicates it to the server application 114. The RC-S page navigation message includes a page identifier, which RCA 142 determines based on the locally stored current page value and the page navigation event. For example, if the locally stored current page value is n, and the page navigation event is a ‘next page’ event, RCA 142 determines the page identifier to be (n+1). Conversely, if the page navigation event was a previous page event, RCA 142 would determine the page identifier to be (n−1). In the example data specification below, the “message RemoteControllerPageNavigationClientSyncMessage” provides an example RC-S page navigation message format.

On receiving a RC-S page navigation message, server application 114 generates (at 1112) a page navigation command record that includes the page ID included in the received message and adds this record to the page navigation commands stream.

As a further illustration of process 1100, consider a presentation effect type RC event triggered (and detected at 1102) by user activation of RC effect control 2008/2102. If presentation effect type RC commands are enabled no further validity checks are required for a presentation effect type command at 1104.

If presentation effect type RC commands are enabled, RCA 142 generates a RC-S effect message and communicates it to the server application 114. The RC-S event message includes an identifier of the effect in question. The particular effect may be identified by RCA 142 based on the particular effect control 2102 that has been activated. For example, effect control 2102A may be in respect of a confetti shower effect. In this case, activation of effect control 2102 causes RCA 142 to generate a RC-S effect message that includes an identifier of the confetti shower effect. In the example data specification below, the “message RemoteControllerEffectClientSyncMessage” provides an example RC-S page navigation message format.

On receiving a RC-S effect message, server application 114 generates (at 1112) an effect command record that includes the effect ID included in the received message and adds this record to the effect commands stream.

### Remote Controller: Processing Stream Messages

While a RCS is active, a remote controller's RCA 142 will receive messages from server application 114 over the RCS remote controller streaming connection. These will be referred to as server-to-remote controller (S-RC) stream messages. Processing S-RC stream messages by a controller's RCA 142 will be described with reference to process 1200 of FIG. 12.

At 1202, the remote controller's RCA 142 receives a S-RC stream message. In the example data specification below, the “message RemoteControllerServerSyncMessage” and associated data structures provide example S-RC stream message formats.

At 1204, RCA 142 determines a type of the S-RC stream message. In the present embodiment, the received message is either: a S-RC controller count update message (in which case processing proceeds to 1206); a S-RC RC command message (in which case processing proceeds to 1208); a S-RC state update message (in which case processing proceeds to 1210).

At 1206, the stream message received at 1202 is a controller count update message. In this case the message will include a current number of remote controllers that are currently connected to the RCS. At 1206, RCA 142 updates the locally stored RCS data to store the new connected remote controller count value. In addition, RCA 142 updates the remote control UI to display the number of currently connected remote controllers (e.g. via state indicator 2002). In the example data specification below, the “message RemoteControllerControllerCountServerSyncMessage” provides an example S-RC controller count update message format.

If the stream message received at 1202 is a S-RC RC command message, processing proceeds to 1208. In this case, RCA 142 updates the locally RCS data based on the data included in the message (which, in turn, will depend on the type of RC command the message is in respect of). In addition, RCA 142 may update the remote controller UI based on the message.

For example, if the S-RC RC command message is a page navigation message, it will include a page identifier (e.g. a page index). In this case RCA 142 will update the locally stored current page value. In the example data specification below, the “message RemoteControllerPageNavigationServerSyncMessage” provides an example S-RC page navigation message format.

If the stream message received at 1202 is a S-RC state message, processing proceeds to 1210. In this case, the message will include a current state and may also include a current page identifier and a maximum page number. RCA 142 uses the message data to update the locally stored RCS data—e.g. the locally stored state, current page value, and max page value (depending on the message). If the remote control user interface displays such information this may also be updated. For example, application 142 may update the remote control interface to alert the user that the RCS (or a specific remote control command type) has been enabled or disabled. RCA 142 may also, or alternatively, enable or disable user interface controls based on the current state. For example, if the state message indicates an enabled state, UI controls such as page navigation controls 2004 and 2006 and/or effect control 2008 may be enabled (or displayed if not already displayed). Conversely, if the state message indicates a disabled state, UI controls such as page navigation controls 2004 and 2006 and/or effect control 2008 may altered to indicate this—for example, by hiding the relevant control or otherwise altering the appearance of the control to indicate it is disable (e.g. by greying out the control or applying an alternative visual effect). In the example data specification below, the “message RemoteControllerRemoteControlStateServerSyncMessage” provides an example S-RC state message format.

### Controller: Disconnecting from RCS

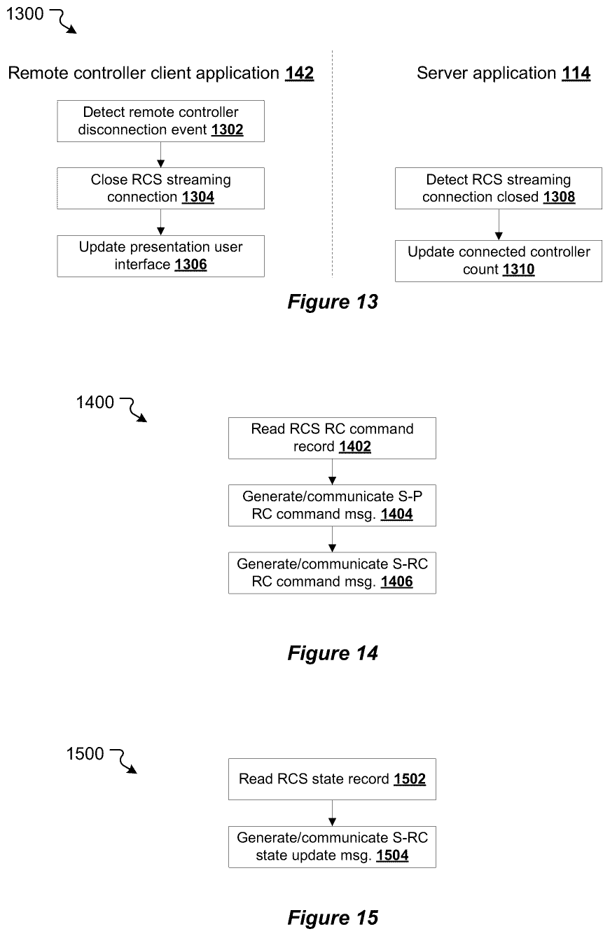

While a RCS is active, a remote controller may (via their RCA 142) disconnect from the RCS. This will be described with reference to process 1300 of FIG. 13.

At 1302, RCA 142 detects a remote controller disconnection event. The remote controller disconnection event may be triggered in various ways. For example, a remote controller may activate a disconnect control (such as control 2014of remote control UI 2000). Alternatively, RCA 142 may be configured such that a remote controller disconnection event automatically occurs if no activity relating to the RCS occurs within a defined disconnection period (e.g. 15 minutes, 30 minutes, or any other appropriate period).

At 1304, in response to detecting the presenter disconnection event, PCA 132 closes the RCS presenter streaming connection (e.g. closes the websocket).

RCA 142 may close the RCS remote controller streaming connection in other ways—for example by RCA 142 itself being closed (or crashing) or client system 140 being shut down/put into a sleep mode, etc.

In addition, and if the remote control user interface is still displayed, at 1306 RCA 142 updates the remote control UI as appropriate. This may involve closing the remote control UI (and/or page on which it is presented) entirely, or ceasing to display particular UI elements associated with the RCS.

At 1308, server application 114 detects that the RCS remote control streaming connection with the remote controller's RCA 142 has been closed.

At 1310, server application 114 updates (e.g. decrements) the connected controller count (e.g. by updating the RCS controller count), e.g. by a Redis command such as:
DECR remote:{<RCS_ID>}:controllercount

As described above with reference to updating the presenter count (at 522), server application 114 may be configured to perform additional checks before updating the controller count at 1310 (e.g. ensuring the relevant key exists and/or that updating the controller count will not result in an impermissible controller count value (e.g. less than 0)).

### Server Application: Processing Stream Messages

While remote control sessions are active, server application 114 is configured to process RCS data from the IMDB 116. In particular, server application 114 is configured to process RCS state records (that have been added to the RCS state stream) and RCS RC command records (that have been added the relevant RC command streams—such as the RCS page navigation commands stream and RCS effect commands stream).

### Remote Control Command Records

Processing 1400 performed by server application 114 on reading a new RC command record will be described with reference to FIG. 14.

At 1402, server application 114 reads a RC command record from the relevant RC commands stream. In the present embodiments, page navigation command records are read from the page navigation commands stream and presentation effect command records are read from the effects commands stream.

At 1404, server application 114 generates a server-to-presenter (S-P) RC command message and communicates it to the relevant PCA 132. In the present embodiment, this is achieved by adding the message to the presenter sink. From the presenter sink the message is then communicated to the PCA 132 over the RCS presenter streaming connection.

At 1406, and depending on the type of RC command in question, server application 114 generates a server-to-remote controller (S-RC) RC command message for each remote controller connected to the RCS server application and communicates it to each connected RCA 142. In the present embodiment, this is achieved by adding the message to the remote controller sink of each remote controller that is connected to the RCS. From each remote controller sink, the message is then communicated to the relevant RCA 142 over the streaming connection established with that RCA 142.

Not all RC command types will be communicated to connected remote controller applications 142. For example, in the present embodiment page navigation RC commands are communicated to connected remote controller applications 142 so those applications can update the current presentation page. Presentation effect RC commands, however, do not need to be communicated to connected remote controller applications 142.

The specific format of the S-P and S-RC RC command messages (and data included therein) will depend on the type of command that the RC command record defines.

By way of example, the RC command record read at 1402 may be a page navigation command record. In this case, server application 114: generates a S-P page navigation message and communicates it to the relevant presenter PCA 132 at 1404; and generates a server-remote controller (S-RC) page navigation message and communicates it to the relevant remote controller RCA 142 at 1406.

As a further example, the RC command record read at 1402 may be a presentation effect command record. In this case, server application 114: generates a S-P effect message and communicates it to the relevant presenter PCA 132 at 1404. As the record relates to a presentation effect RC command, server application 114 does not generate/communicate messages to connected remote controller applications 142.

In the example data specification below, the “message RemotePresenterPageNavigationServerSyncMessage” provides an example S-P page navigation message format, the “message RemoteControllerPageNavigationServerSyncMessage” provides an example S-RC page navigation message format, and the “message RemotePresenterEffectServerSyncMessage” provides an example S-P effect message format.

### State Records

Processing 1500 performed by server application 114 on reading a new RCS state record will be described with reference to FIG. 15.

At 1502, server application 114 reads a state record from the RCS state stream.

At 1504, for each remote controller connected to the RCS server application generates a server-remote controller (S-RC) state update message and communicates it to the RCA 142. In the present embodiment, this is achieved by adding the message to the remote controller sink of each remote controller that is connected to the RCS. From each remote controller sink, the message is then communicated to the relevant RCA 142 over the streaming connection established with that RCA 142.

In the example data specification below, the “message RemoteControllerRemoteControlStateServerSyncMessage” provides an example S-RC state update message format.

### Server Application: Detect Change in Controller Count

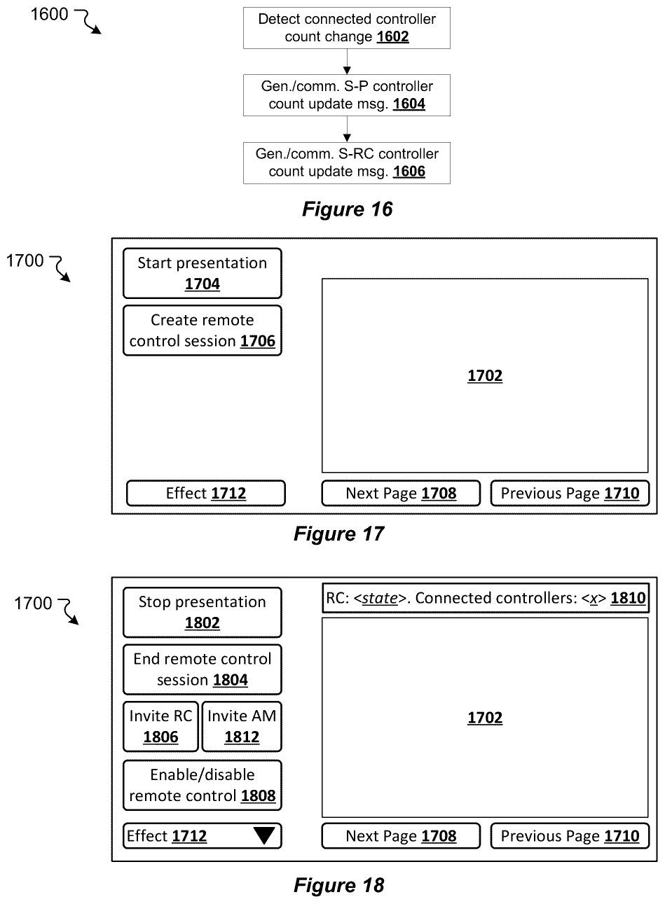

While remote control sessions are active, server application 114 is also configured to monitor the number of remote controllers connected to each RCS. Processing 1600 performed by server application 114 on detecting a change in the number of connected remote controllers for a given RCS will be described with reference to FIG. 16.

At 1602, server application 114 detects a change in the number of connected remote controllers for a particular RCS. In the present example, server application detects this by monitoring the RCS controller count strings (e.g. periodically determining the controller count), though could be done via a publication/subscription or other alerting mechanism.

At 1604, server application 114 generates a server-to-presenter (S-P) controller count update message and communicates it to the relevant presenter PCA 132. In the present embodiment, this is achieved by adding the message to the presenter sink. From the presenter sink the message is then communicated to the PCA 132 over the RCS presenter streaming connection. In the example data specification below, the “message RemotePresenterControllerCountServerSyncMessage” provides an example S-P controller count update message format.

At 1606, for each remote controller connected to the RCS, server application 114 generates a server-to-remote controller (S-RC) controller count update message and communicates it to the RCA 142. In the present embodiment, this is achieved by adding the message to the remote controller sink of each remote controller that is connected to the RCS. From each remote controller sink, the message is then communicated to the relevant RCA 142 over the streaming connection established with that RCA 142.

In the example data specification below, the “message RemoteControllerControllerCountServerSyncMessage” provides an example S-RC controller count update message format.

### Alternative Embodiments

It will be appreciated that variations to and adaptations of the specific examples described above are possible.

By way of example, in the processes described when the server application 114 is processing a remote control command record (e.g. a page navigation command record) that has been added to the relevant remote control command stream (e.g. the page navigation commands stream) the server application 114 is configured to: generate a server-to-presenter remote control command message and communicate this to the presenter client application 132 (at 1404); and generate a server-to-remote controller remote control command message and communicate this to each connected remote controller application 142 (at 1406). A result of this is that if a remote controller application has generated an invalid remote control command (for example it is a command that navigates to a now non-existent presentation page), this command is still communicated to all connected remote controller applications 142. In the case of a page navigation command, this would cause the remote controller application 142 to update its locally stored current page value to an invalid page (at 1208).

In an alternative embodiment, the processing described above is adapted so that only the presenter application 132 can cause a remote controller client application 142 to update its locally stored current page value. One way of modifying the above processing so only a presenter application 132 can cause a remote controller application 142 to update its locally stored current page value is as follows.

When server application 114 reads a page navigation command record from the page navigation commands stream (at 1402), it only generates a server-to-presenter remote control command message and communicates this to the presenter application 132 (at 1404). In this case, the server application 114 does not generate/communicate any message to connected remote controller applications 142 (at 1406).

When the presenter client application 132 receives a server-to-presenter stream message, it processes this as described above with reference to FIG. 8. When processing a server-to-presenter command message that defines a page navigation command (at 816), however, if the page navigation command is valid (e.g. it defines a valid page that the presenter client application 132 navigates to), the presenter client application 132 also generates a presenter-to-server state update message and communicates this to the server application 114. This is similar to the generation of a state update message as described at 604 above. Here, however, the presenter-to-server state update message is generated to include the new current page of the presentable (i.e. after the presenter client application 132 has updated the current page in accordance with the page navigation command).

In such embodiments, the presenter client application 132 will not need to ever emit a page navigation command. Instead, whenever the presenter client application 132 changes a page of the presentable it generates/emits a presenter-to-server state update message that includes data in respect of the presentation page change. This is whether the page navigation is initiated by the presenter application 132 itself (e.g. as described above with reference to FIG. 7) or initiated by a remote controller client application 142 (e.g. in response to receiving and processing a server-to-presenter page navigation command received while the remote control session state is enabled).

On receiving the presenter-to-server state update message that defines the new current page (at 608), the server application 114 generates a state record and adds this to the state stream. This is similar to the processing described at 610 above, with the relevant record that is generated recording a page identifier that is based on the received state update message.

Once the server application 114 has added the state record to the state stream, processing continues as described above. E.g.: the server application 114 reads the state record (at 1502) and communicates server-to-remote controller state update messages to connected remote controller client applications 142 (at 1504); and a connected remote controller client application 142 receives the server-to-remote controller state update message (at 1202) and processes it (at 1210—which, in this case, involves the remote controller client application 142 updating its locally stored current page value).

### Example Data Specification

This section provides example data formats for records, messages, requests and responses described above. It will be appreciated that these are provided by example only and many alternative data formats (defining the same, additional, or alternative specific fields) are possible.

```
message RemoteControlState {
    oneof kind {
      RemoteControlEnabledState enabled = 1;
      RemoteControlDisabledState disabled = 2;
      RemoteControlDisconnectedState presenter_disconnected = 3;
    }
  }
  message RemoteControlEnabledState {
    required int32 current_page_index = 1;
    required int32 max_pages = 2;
  }
  message RemoteControlDisabledState {
  }
  message RemoteControlDisconnectedState {
  }
  message RemoteControllerSessionInfo {
    // Unique identifier for the RC session
    required string session_id = 1;
    // Most recent state update of the RC session
    required RemoteControlState control_state = 2;
    // Number of controllers connected to the RC session
    required int32 controller_count = 3;
  }
  message RemotePresenterSessionInfo {
    // Unique identifier for the RC session
    required string session_id = 1;
    // Number of presenters connected to the RC session
    required int32 presenter_count = 2;
    // Number of controllers connected to the RC session
    required int32 controller_count = 3;
    // Time at which the remote control session will expire
    required int64 expiry_timestamp = 4;
    // Remote control link, including session connection token
    required string url= 5;
    // Whether remote control will be in an enabled or disabled state upon connection
    required bool is_enabled = 6;
  }
message RemotePresenterClientSyncMessage {
    oneof kind {
      RemotePresenterPageNavigationClientSyncMessage page_navigation = 1;
      RemotePresenterRemoteControlStateClientSyncMessage control_state = 2;
    }
  }
  message RemotePresenterPageNavigationClientSyncMessage {
    required int32 destination_page_index = 1;
  }
  message RemotePresenterRemoteControlStateClientSyncMessage {
    required RemoteControlState state = 1;
  }
////////////////////////////////////////////////////////////////////////////////////////////////////////
  message RemotePresenterServerSyncMessage {
    oneof kind {
      RemotePresenterControllerCountServerSyncMessage controller_count = 1;
      RemotePresenterPageNavigationServerSyncMessage page_navigation = 2;
      RemotePresenterEffectServerSyncMessage effect_id = 3;
    }
  }
  message RemotePresenterControllerCountServerSyncMessage {
    required int32 controller_count = 1;
  }
  message RemotePresenterPageNavigationServerSyncMessage {
    required int32 destination_page_index = 1;
  }
  message RemotePresenterEffectServerSyncMessage {
    required Effect effect = 1;
  }
////////////////////////////////////////////////////////////////////////////////////////////////////////
  message RemoteControllerClientSyncMessage {
    oneof kind {
      RemoteControllerPageNavigationClientSyncMessage page_navigation = 1;
      RemoteControllerEffectClientSyncMessage effect = 2;
    }
  }
  message RemoteControllerPageNavigationClientSyncMessage {
    required int32 destination_page_index = 1;
  }
  message RemoteControllerEffectClientSyncMessage {
    required Effect effect = 1;
  }
////////////////////////////////////////////////////////////////////////////////////////////////////////
  message RemoteControllerServerSyncMessage {
    oneof kind {
      RemoteControllerControllerCountServerSyncMessage controller_count = 1;
      RemoteControllerPageNavigationServerSyncMessage page_navigation = 2;
      RemoteControllerRemoteControlStateServerSyncMessage control_state = 3;
    }
  }
  message RemoteControllerControllerCountServerSyncMessage {
    required int32 controller_count = 1;
  }
  message RemoteControllerPageNavigationServerSyncMessage {
    required int32 destination_page_index = 1;
  }
  message RemoteControllerRemoteControlStateServerSyncMessage {
    required RemoteControlState state = 1;
  }
////////////////////////////////////////////////////////////////////////////////////////////////////////
  message CreateRemoteSessionRequest {
    required Presentable presentable = 1;
  }
  message CreateRemoteSessionResponse {
    required RemotePresenterSessionInfo session = 1;
  }
  message FindRemoteSessionRequest {
    required Presentable presentable = 1;
  }
  message FindRemoteSessionResponse {
    optional RemotePresenterSessionInfo session = 1;
  }
  message GetRemoteControllerSessionInfoRequest {
    required string session_id = 1;
  }
  message GetRemoteControllerSessionInfoResponse {
    required RemoteControllerSessionInfo = 1;
  }
  message Presentable {
    enum Type {
      DOCUMENT = 1;
      PLAYLIST = 2;
    }
    // The id of the asset. Will be document id in the case of a document
    // or playlist id in the case of a playlist.
    required string id = 1;
    // The type of the asset that is presented.
    required Type type = 2;
  }
message Effect{
    oneof kind {
      Timer timer = 1;
      Blur blur = 2;
      Quiet quiet = 3;
      Bubbles bubbles = 4;
      Confetti confetti = 5;
      Drumroll drumroll = 6;
    }
  }
  message Timer {
    required int32 duration_seconds = 1;
  }
  message Blur {
  }
  message Quiet {
  }
  message Bubbles {
  }
  message Confetti {
  }
  message Drumroll {
  }
////////////////////////////////////////////////////////////////////////////////////////////////////////
/*
    * Requests a stream from the server through which the user can send and receive
    * remote control commands
    *
    * This method will throw a Flux.error(NotFoundException) if there is no session
    * matching the provided RCS ID.
    */
  rpc connectRemoteController (stream RemoteControllerClientSyncMessage) returns
(stream RemoteControllerServerSyncMessage);
  /*
    * Requests a stream from the server through which a presenter can send and receive
    * remote control events.
    *
    * This method will throw a Flux.error(NotFoundException) if there is no session
    * matching the provided RCS ID.
    *
    * This method will throw a Flux.error(ForbiddenException) if there is already a
    * presenter connected to the session.
    */
  rpc connectRemotePresenter (stream RemotePresenterClientSyncMessage) returns
(stream RemotePresenterServerSyncMessage);
  /*
    * This starts a new remote control session. User attempting to start this session must
    * be authorized to access associated presentable.
    *
    * If a session has already been created for the presentable by the user, then a
    * 403/ForbiddenException will be thrown.
    *
    * If the presentable was not found, then a 404/NotFoundException will be thrown.
    */
  rpc createRemoteSession (CreateRemoteSessionRequest) returns
(CreateRemoteSessionResponse);
  /*
    * This will fetch an existing presenter session for the asset, if one exists. There may
    * not be more than one matching session. If no session was found, the response will
    * be empty.
    *
    * This method will not throw any HTTP errors.
    */
  rpc findRemoteSession (FindRemoteSessionRequest) returns
(FindRemoteSessionResponse);
  /*
    * Gets the current state of the remote session for the provided session id.
    *
    * If the session does not exist, then a 404/NotFoundException will be thrown.
    */
  rpc getRemoteControllerSessionInfo (GetRemoteControllerSessionInfoRequest)
returns (GetRemoteControllerSessionInfoResponse);
/*
    * Requests a stream from the server through which a controller can send and receive
    * remote control events.
    *
    * This method will throw a Flux.error(NotFoundException) if there is no session
    * matching the provided RCS ID.
    */
  rpc connectRemoteController (stream RemoteControllerClientSyncMessage) returns
(stream RemoteControllerServerSyncMessage) {
    option (protogen.request_message) =
“livepresentation.ConnectRemoteControllerApiRequest”;
  }
  message ConnectRemoteControllerApiRequest {
    required string remote_control_id = 1 [(protogen.http_match) = “([a-f0-9]{8}(-[a-f0-
9]{4}){4}[a-f0-9]{8})”];
  }
  /*
    * Requests a stream from the server through which a presenter can send and receive
    * remote control events.
    *
    * This method will throw a Flux.error(NotFoundException) if there is no session
    * matching the provided RCS ID.
    */
  rpc connectRemotePresenter (stream RemotePresenterClientSyncMessage) returns
(stream RemotePresenterServerSyncMessage) {
    option (protogen.request_message) =
“livepresentation.ConnectRemotePresenterApiRequest”;
  }
  message ConnectRemotePresenterApiRequest {
    required string remote_control_id = 1 [(protogen.http_match) = “([a-f0-9]{8}(-[a-f0-
9]{4}){4}[a-f0-9]{8})”];
    required int32 current_page_index = 2;
    required int32 max_pages = 3;
  }
  /*
    * This starts a new remote control session. User attempting to start this session must
    * be authorized to access associated presentable.
    *
    * If a session has already been created for the presentable by the user, then a
    * 403/ForbiddenException will be thrown.
    *
    * If the presentable was not found, then a 404/NotFoundException will be thrown.
    */
  rpc createRemoteSession (CreateRemoteSessionApiRequest) returns
(CreateRemoteSessionApiResponse) {
    option (google.api.http) = {
      post: “/remote”
      body: “*”
    }
  }
  message CreateRemoteSessionApiRequest {
    required Presentable presentable = 1;
  }
  message CreateRemoteSessionApiResponse {
    required RemotePresenterSessionInfo session = 1;
  }
  /*
    * This will fetch an existing presenter session for the asset, if one exists. There may
    * not be more than one matching session. If no session was found, the response will
    * be empty.
    *
    * This method will not throw any HTTP errors.
    */
  rpc findRemoteSession (FindRemoteSessionApiRequest) returns
(FindRemoteSessionApiResponse) {
    option (google.api.http) = {
      get: “/remote”
    }
  }
  message FindRemoteSessionApiRequest {
    required Presentable presentable = 1;
  }
  message FindRemoteSessionApiResponse {
    optional RemotePresenterSessionInfo session = 1;
  }
message RemoteMetadataRecord {
    required string remote_control_id = 1;
    required string presenter_user = 2;
    required Presentable presentable = 3;
    required int64 start_timestamp = 4;
  }
  message RemoteControlEventRecord {
    required RemoteControlCommandRecord command = 1;
    required int64 create_timestamp = 2;
  }
  message RemoteControlCommandRecord {
    oneof kind {
      PageNavigationCommandRecord page_navigation = 1;
      RemoteControlStateCommandRecord remote_control_status = 2;
      PresentationEffectCommandRecord effect = 3;
    }
  }
  message PageNavigationCommandRecord {
    required int32 destination_page_index = 1;
  }
  Message PresentationEffectCommandRecord {
    required Effect effect = 1;
  }
  message RemoteControlStateCommandRecord {
    required RemoteControlState status = 1;
    optional int32 current_page_index = 2;
  }
```

The following numbered clauses provide specific examples of embodiments described herein:
Clause 1. A computer implemented method including:
receiving a connect presenter request from a presenter application, the connect presenter request identifying a remote control session (RCS), the RCS being associated with a presentation document;
establishing a RCS presenter connection with the presenter application;
receiving a connect remote controller request from a remote controller application, the connect remote controller request identifying the RCS;
establishing a RCS remote controller connection with the remote controller application;
receiving, over the RCS remote controller connection, a remote controller-to-server command message defining a remote control command; and
in response to receiving the remote controller-to-server command message:
generating a server-to-presenter command message, the server-to-presenter command message including command data in respect of the remote control command; and
communicating the server-to-presenter command message to the presenter application over the RCS presenter connection.
Clause 2. The computer implemented method of clause 1, wherein the RCS presenter connection is a streaming connection.
Clause 3. The computer implemented method of clause 1 or clause 2, wherein the RCS remote controller connection is a streaming connection.
Clause 4. The computer implemented method of any one of clauses 1 to 3, wherein on receipt of the connect remote controller request the method further includes: updating a remote controller count;
generating a server-to-presenter controller count message indicating the updated remote controller count;
communicating the server-to-presenter controller count message to the presenter application over the RCS presenter connection, wherein receipt of the server-to-presenter controller count message by the presenter application causes the presenter application to display the updated remote controller count in a presentation user interface.
Clause 5. The computer implemented method of any one of clauses 1 to 4, wherein in response to receiving the remote controller-to-server command message the method further includes:
generating a remote control command record including data in respect of the remote control command; and
saving the remote control command record to a database.
Clause 6. The computer implemented method of clause 5, wherein the remote control command record is saved to an ordered set of remote control command records.
Clause 7. The computer implemented method of clause 6, wherein generating the server-to-presenter remote control command message is in response to processing the remote control command record from the stream of remote control command records.
Clause 8. The computer implemented method of any one of clauses 1 to 7, wherein:
the remote controller-to-server command message defines a page navigation command and identifies a particular page of the presentation document; and
the command data includes an identifier of the particular page.
Clause 9. The computer implemented method of any one of clauses 1 to 7, wherein:
the remote controller-to-server remote control command message defines a presentation effect command and identifies a particular presentation effect; and
the command data includes an identifier of the particular effect.
Clause 10. The computer implemented method of any one of clauses 1 to 9, further including:
receiving, over the RCS presenter connection, a presenter-to-server state update message, the state update message defining a RCS state change;
generating a server-to-remote controller state update message, the server-to-remote controller state update message including state update data in respect of the state change; and
communicating the server-to-remote controller state update message to the remote controller application over the RCS remote controller connection.
Clause 11. The computer implemented method of clause 10, wherein the RCS state change is selected from a group including: an enable remote control state change; a disable remote control state change; an enable remote control command type state change; a disable remote control command type state change; an enable remote controller state change; a disable remote controller state change; an enable remote control command type for remote controller state change; a disable remote control command type for remote controller state change; a page update state change.
Clause 12. The computer implemented method of clause 10 or clause 11, wherein in response to receiving the presenter-to-server state update message the method further includes:
generating a state update record including data in respect of the state update; and
saving the state update record to a database.
Clause 13. The computer implemented method of clause 12, wherein the state update record is saved to a stream of state update records.
Clause 14. The computer implemented method of clause 13, wherein generating the server-to-remote controller state update message is in response to processing the state update record from the stream of remote control command records.
Clause 15. The computer implemented method of any one of clauses 1 to 14, wherein the connect presenter request further includes one or both of: a current page identifier and a maximum page number.
Clause 16. The computer implemented method of any one of clauses 5 to 7 or clauses 12 to 14, wherein the database is an in memory database.
Clause 17. A computer implemented method including:
displaying, on a display, an initial page of a presentation document in a presentation user interface;
joining a presentation session via which the initial page is displayed at a plurality of audience member client systems;
establishing a remote control session (RCS) presenter connection with a server application, the RCS presenter connection being associated with a RCS, the RCS having a RCS identifier and being associated with the presentation document;
receiving, over the RCS presenter connection, a page navigation message identifying a new page of the presentation document; and
in response to receiving the page navigation message, updating the presentation user interface to display the new page; and
causing the new page to be displayed at the plurality of audience member client systems.
Clause 18. The computer implemented method of clause 17, wherein the RCS presenter connection is a streaming connection.
Clause 19. The computer implemented method of clause 17 or clause 18, wherein establishing the RCS presenter connection includes:
generating a create RCS request, the create RCS request including an identifier of the presentation document;
communicating the create RCS request to the server application;
receiving a create RCS response from the server application, the create RCS response including the RCS identifier;
generating a connect presenter request, the connect presenter request including the RCS identifier;
communicating the connect presenter request to the server application;
receiving RCS connection data from the server application; and
establishing the RCS presenter connection with the server application using the RCS connection data.
Clause 20. The computer implemented method of clause 19, wherein the connect presenter request further includes one or both of: a current page identifier and a maximum page number.
Clause 21. The computer implemented method of any one of clauses 17 to 20, further including:
receiving, over the RCS presenter connection, a presentation effect message identifying a presentation effect;
causing the identified presentation effect to be played in the presentation user interface; and
causing the identified presentation effect to be played at the plurality of audience member client systems.
Clause 22. The computer implemented method of any one of clauses 17 to 21, further including:
receiving, over the RCS presenter connection, a controller count update message indicating a number of remote controllers; and
updating the presentation user interface to display the number of remote controllers.
Clause 23. The computer implemented method of any one of clauses 17 to 22, further including:
detecting a state change event defining a RCS state change;
in response to detecting the state change event, generating a presenter-to-server state update message including state update data in respect of the state change; and
communicating the state update message to the server application over the RCS presenter connection.
Clause 24. The computer implemented method of clause 23, wherein the state change event is triggered by user interaction with a state change control displayed in the presentation user interface.
Clause 25. The computer implemented method of clause 23 or clause 24, wherein the state change is selected from a group including: an enable remote control state change; a disable remote control state change; an enable remote control command type state change; a disable remote control command type state change; an enable remote controller state change; a disable remote controller state change; an enable remote control command type for remote controller state change; a disable remote control command type for remote controller state change; a page update state change.
Clause 26. The computer implemented method of any one of clauses 17 to 25, further including:
generating a remote controller invitation, the remote controller invitation including remote controller connection data, the remote controller connection data being usable by a remote controller application to establish a remote controller connection with the server application; and
communicating the remote controller invitation to a remote controller.
Clause 27. The computer implemented method of clause 26, wherein the remote controller connection data includes a URL that includes the RCS identifier.
Clause 28. A computer implemented method including:
establishing a remote control session (RCS) remote controller connection with a server application, the RCS remote controller connection being associated with a RCS, the RCS having a RCS identifier and being associated with a presentation document;
displaying, on a display, a remote control user interface, the remote control user interface including a page navigation control;
detecting activation of the page navigation control; and
in response to detecting activation of the page navigation control:
determining a new page of the presentation document;
generating a remote controller-to-server page navigation message identifying the new page;
communicating the remote controller-to-server page navigation message to the server application over the RCS remote controller connection.
Clause 29. The computer implemented method of clause 28, further including:
receiving, over the RCS remote controller connection, a state update message, the state update message identifying a current page and a maximum page number, the current page being a page of the presentation document displayed by a presenter client application;
storing the current page in local memory; and
storing the maximum page number in the local memory.
Clause 30. The computer implemented method of clause 28 or clause 29, further including:
receiving, over the RCS remote controller connection, a server-to-remote controller page navigation message, the server-to-remote controller page navigation message identifying a new current page; and
storing the new current page in the local memory.
Clause 31. The computer implemented method of clause 29 or clause 30, further including displaying, in the remote control user interface, the current page and/or the maximum page number as stored in the local memory.
Clause 32. The computer implemented method of any one of clauses 29 to 31, wherein prior to generating a page navigation message the method further includes:
determining, based on the current page and maximum page number as stored in local memory, whether the new page is a valid page of the presentation document;
in response to determining that the new page is a valid page, generating and communicating the page navigation message; and
in response to determining that the new page is not a valid page, foregoing generation and communication of the page navigation message.
Clause 33. The computer implemented method of any one of clauses 28 to 32, further including:
displaying a presentation effect control in the remote control user interface;
detecting activation of the presentation effect control; and
in response to detecting activation of the presentation effect control:
determining a particular presentation effect;
generating a presentation effect message including an identifier of the particular presentation effect; and
communicating the presentation effect message to the server application over the RCS remote controller connection.
Clause 34. The computer implemented method of any one of clauses 28 to 33, further including:
receiving, over the RCS remote controller connection, a state update message, the state update message defining a disabled state;
in response to receiving the state update message, disabling the page navigation control.
Clause 35. A computer processing system including:
a processing unit;
a communication interface; and
a non-transient computer-readable storage medium storing instructions, which when executed by the processing unit, cause the processing unit to perform a method according to any one of clauses 1 to 16.
Clause 36. A computer processing system including:
a processing unit;
a display;
a communication interface; and
a non-transient computer-readable storage medium storing instructions, which when executed by the processing unit, cause the processing unit to perform a method according to any one of clauses 17 to 27.
Clause 37. A computer processing system including:
a processing unit;
a display;
a communication interface; and
a non-transient computer-readable storage medium storing instructions, which when executed by the processing unit, cause the processing unit to perform a method according to any one of clauses 28 to 34.
Clause 38. A non-transient storage medium storing instructions executable by processing unit to cause the processing unit to perform a method according to any one of clauses 1 to 16, 17 to 27, or 28 to 34.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

Although the present disclosure uses terms “first,” “second,” etc. to describe various elements, these terms are used only to distinguish elements from one another and not in an ordinal sense. For example, a first RC command type could be termed a second RC command type or vice versa without departing from the scope of the described examples. Furthermore, when used to differentiate elements or features, a second RC command type could exist without a first RC command type. For example, a second user input could occur before a first user input (or without a first user input ever occurring).

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A computer implemented method for controlling remote controllers of an electronic presentation, wherein the electronic presentation involves presenting a document to one or more audience member applications and the method comprises:
establishing a presenter connection with a first application that is operating is a presenter mode of operation;
establishing a first remote controller connection with a second application that is operating in a remote controller mode of operation, wherein on establishing the first remote controller connection a first type of remote-control command is enabled for the second application and a user of the second application can perform, via the second application, the first type of remote control command to cause a first type of action to be performed in the electronic presentation;
after establishing the first remote controller connection, receiving, over the presenter connection, a first state update message; and
in response to receiving the first state update message, disabling the first type of remote-control command for the second application so that the user of the second application can no longer cause the first type of action to be performed in the electronic presentation.

2. The computer implemented method of claim 1, wherein:
the method further comprises establishing a second remote controller connection with a third application that is operating in the remote controller mode of operation, wherein on establishing the second remote controller connection, the first type of remote-control command is enabled for the third application;
the first state update message indicates that the first type of remote-control command is to be disabled for all remote controllers; and
in response to receiving the first state update message, the first type of remote-control command is disabled for the third application as well as the second application.

3. The computer implemented method of claim 1, wherein:
the method further comprises establishing a second remote controller connection with a third application that is operating in the remote controller mode of operation, wherein on establishing the second remote controller connection, the first type of remote-control command is enabled for the third application;
the first state update message indicates that the first type of remote-control command is to be disabled for the second application only; and
in response to receiving the first state update message, the first type of remote-control command is disabled for the second application but not for the third application.

4. The computer implemented method of claim 1, wherein:
on establishing the first remote controller connection, a plurality of different types of remote-control commands are enabled for the second application;
the first state update message indicates that all types of remote-control commands are to be disabled; and
in response to receiving the first state update message, the plurality of different types of remote-control commands are disabled for the second application.

5. The computer implemented method of claim 1, wherein:
on establishing the first remote controller connection, a second type of remote-control command is enabled for the second application;
the first state update message indicates that only the first type of remote-control command is to be disabled; and
in response to receiving the first state update message, the first type of remote-control command is disabled for the second application but the second type of remote-control command is not disabled for the second application.

6. The computer implemented method of claim 1, wherein:
on establishing the first remote controller connection, a plurality of types of remote-control commands are enabled for the second application;
the method further comprises establishing a second remote controller connection with a third application that is operating in the remote controller mode of operation, and wherein on establishing the second remote controller connection the plurality of types of remote-control commands are enabled for the third application;
the first state update message indicates that all types of remote-control commands are to be disabled for all remote controllers; and
in response to receiving the first state update message, the plurality of types of remote-control commands are disabled for the second application and the plurality of types of remote-control commands are disabled for the third application.

7. The computer implemented method of claim 1, wherein:
the first type of remote-control command is a page navigation type command; and
the user of the second application can perform, via the second application, the page navigation type command to cause a page of the document to change.

8. The computer implemented method of claim 1, wherein:
the first type of remote-control command is a presentation effect type command;
and the user of the second application can perform, via the second application, the presentation effect type command to cause a visual effect to be displayed on a page of the document.

9. The computer implemented method of claim 1, wherein the first state update message is received from the first application in response to a presenter activating a state change user interface control that is displayed by the first application.

10. The computer implemented method of claim 1, wherein disabling the first type of remote-control command for the second application includes:
generating a second state update message; and
communicating the second state update message to the second application over the first remote controller connection.

11. The computer implemented method of claim 10, wherein communication of the second state update message to the second application causes the second application to disable or hide a remote control user interface control that is displayed by the second application prior to receiving the second state update message.

12. A computer processing system including:
one or more processing units;
a communication interface; and
one or more non-transient computer-readable storage media storing instructions, which when executed by the one or more processing units, cause the one or more processing units to perform a method for controlling remote controllers of an electronic presentation, wherein the electronic presentation involves presenting a document to one or more audience member applications and the method comprises:
establishing a presenter connection with a first application that is operating is a presenter mode of operation;
establishing a first remote controller connection with a second application that is operating in a remote controller mode of operation, wherein on establishing the first remote controller connection a first type of remote-control command is enabled for the second application and a user of the second application can perform, via the second application, the first type of remote control command to cause a first type of action to be performed in the electronic presentation;
after establishing the first remote controller connection, receiving, via the communication interface and over the presenter connection, a first state update message; and
in response to receiving the first state update message, disabling the first type of remote-control command for the second application so that the user of the second application can no longer cause the first type of action to be performed in the electronic presentation.

13. The computer processing system of claim 12, wherein:
the method further comprises establishing a second remote controller connection with a third application that is operating in the remote controller mode of operation, wherein on establishing the second remote controller connection, the first type of remote-control command is enabled for the third application;
the first state update message indicates that the first type of remote-control command is to be disabled for all remote controllers; and
in response to receiving the first state update message, the first type of remote-control command is disabled for the third application as well as the second application.

14. The computer processing system of claim 12, wherein:
the method further comprises establishing a second remote controller connection with a third application that is operating in the remote controller mode of operation, wherein on establishing the second remote controller connection, the first type of remote-control command is enabled for the third application;
the first state update message indicates that the first type of remote-control command is to be disabled for the second application only; and
in response to receiving the first state update message, the first type of remote-control command is disabled for the second application but not for the third application.

15. The computer processing system of claim 12, wherein:
on establishing the first remote controller connection, a plurality of different types of remote-control commands are enabled for the second application;
the first state update message indicates that all types of remote-control commands are to be disabled; and
in response to receiving the first state update message, the plurality of different types of remote-control commands are disabled for the second application.

16. The computer processing system of claim 12, wherein:
on establishing the first remote controller connection, a second type of remote-control command is enabled for the second application;
the first state update message indicates that only the first type of remote-control command is to be disabled; and
in response to receiving the first state update message, the first type of remote-control command is disabled for the second application but the second type of remote-control command is not disabled for the second application.

17. The computer processing system of claim 12, wherein:
on establishing the first remote controller connection, a plurality of types of remote-control commands are enabled for the second application;
the method further comprises establishing a second remote controller connection with a third application that is operating in the remote controller mode of operation, and wherein on establishing the second remote controller connection the plurality of types of remote-control commands are enabled for the third application;
the first state update message indicates that all types of remote-control commands are to be disabled for all remote controllers; and
in response to receiving the first state update message, the plurality of types of remote-control commands are disabled for the second application and the plurality of types of remote-control commands are disabled for the third application.

18. The computer processing system of claim 12, wherein:
the first type of remote-control command is a page navigation type command; and
the user of the second application can perform, via the second application, the page navigation type command to cause a page of the document to change.

19. The computer processing system of claim 12, wherein:
the first type of remote-control command is a presentation effect type command;
and the user of the second application can perform, via the second application, the presentation effect type command to cause a visual effect to be displayed on a page of the document.

20. One or more non-transient computer-readable storage media storing instructions, which when executed by one or more processing units, cause the one or more processing units to perform a method a method for controlling remote controllers of an electronic presentation, wherein the electronic presentation involves presenting a document to one or more audience member applications and the method comprises:
establishing a presenter connection with a first application that is operating is a presenter mode of operation;
establishing a first remote controller connection with a second application that is operating in a remote controller mode of operation, wherein on establishing the first remote controller connection a first type of remote-control command is enabled for the second application and a user of the second application can perform, via the second application, the first type of remote control command to cause a first type of action to be performed in the electronic presentation;
after establishing the first remote controller connection, receiving, over the presenter connection, a first state update message; and
in response to receiving the first state update message, disabling the first type of remote-control command for the second application so that the user of the second application can no longer cause the first type of action to be performed in the electronic presentation.
